(19) United States
(12) Patent Application Publication
(10) Pub. No.: US 2026/0308437 A1
(43) Pub. Date: Oct. 8, 2026

(54) Heat Transfer Fluids for Electric Vehicles

(71) Applicant: Prestone Products Corporation, Danbury, CT (US)

(72) Inventors: Bo Yang, Danbury, CT (US); Peter M. Woyciesjes, Danbury, CT (US)

(21) Appl. No.: 19/485,207

(22) PCT Filed: May 13, 2024
(86) PCT No.: PCT/US2024/029150

§ 371 Date: Nov. 17, 2025

Related U.S. Application Data
(60) Provisional application No. 63/467,509, filed on May 18, 2023.

(51) Int. Cl. C09K 5/10; H01M 10/653; H01M 10/6567

(52) U.S. Cl. CPC C09K 5/10; H01M 10/653; H01M 10/6567; H01M 2220/20

(57) ABSTRACT

A heat transfer fluid includes bis(2-ethylhexyl) adipate and may also include one or more ultraviolet and sunlight stable, electrically non-conductive solvent colorants or one or more water insoluble colorants.

Effective heat transfer fluids that include bis(2-ethylhexyl) adipate and one or more electrically non-conductive solvent (or water insoluble) dyes and other optional components for use as thermal management fluid in electric vehicles are described.

### BACKGROUND

Heat transfer fluids are essential to the normal operation of automotive vehicles. In traditional automotive vehicles powered by internal combustion engines, glycol-water based heat transfer fluids are used in the cooling systems to provide long-lasting, year-round protection. Some requirements of heat transfer fluids are that they provide efficient heat transfer to control and maintain engine temperature for efficient fuel economy and lubrication, and prevent engine failures due to freeze-up, boil-over, or over-heating, as well as provide effective heat transfer to meet cabin climate control and windshield defrosting requirements. An additional desired requirement of a heat transfer fluid is that it provides effective corrosion protection of all cooling system metals over a wide range of temperature and operating conditions to ensure that it will fulfill all its design functions. An ideal heat transfer fluid for use in the automotive vehicle cooling system powered by internal combustion engine typically has the following desired characteristics or properties.
1. High heat capacity (or high specific heat) and high thermal conductivity
2. Fluidity within the temperature of use
3. Low viscosity
4. Low freezing point
5. High boiling point
6. Compatible with the materials used in the cooling system so that it is capable of providing good corrosion protection to metals used in the system and will not cause degradation of non-metals
7. Chemically stable over the temperature range and condition of use
8. Low foaming tendency
9. Low flammability; high flash point
10. Non-toxic or low toxicity; no unpleasant odor
11. Cost effective and have adequate supply

In addition, it is desirable if heat transfer fluids have a distinct color to provide identity and prevent confusion between different heat transfer fluid technology products and with other functional fluids used in automobiles. Such coloring is also intended to provide information as to the concentration of the heat transfer fluid and to allow the heat transfer fluid to be recognized during and after use in the cooling system.

A single material that possesses the best available values for all the desirable properties for use as heat transfer fluid in the cooling systems of automotive vehicles has not yet been identified. Despite that and since the early 1960's, 50% ethylene glycol-50% water-based engine coolants have been adopted by automakers as factory fill year-round heat transfer fluids in engine cooling systems in the US. Automakers use 50% ethylene glycol-50% water-based engine coolants as factory fill fluids because they provide an acceptable available balance of performance properties in terms of heat transfer, freeze and boil protection, flammability, toxicity, availability, corrosion protection of metals, and compatibility with other materials used in the cooling systems.

Recently, electric vehicles have increasingly attracted consumer's and manufacturer's attention due to the need to reduce emissions during vehicle operation, improve energy efficiency, and reduce the dependency on oil. Generally, there are four types of electric vehicles available on the market. They are as follows.
1. Battery electric vehicles (BEVs)—Propelled only by electric drive. The energy required to run the vehicle is supplied by a high voltage battery that is externally recharged.
2. Hybrid electric vehicles (HEVs)—Propelled by a combination of an internal combustion engine and electric drive. The electric motor runs off a high voltage battery that it is charged in the vehicle via e.g., regenerative braking for greater efficiency. The batteries of an HEV cannot be recharged from an external power source.
3. Plug-in hybrid electric vehicles (PHEVs)—Plug-in hybrids also use high voltage battery to power an electric motor to drive the vehicle and can be recharged from an external power source, but they incorporate a smaller internal combustion engine that can recharge the battery (or in some models, directly power the wheels) to allow for longer driving ranges.
4. Fuel cell electric vehicles (FCEVs)—Propelled only by electric drive. FCEVs generate electricity to power the electric motor via a highly efficient electrochemical process in the fuel cell stack. In the fuel cell stack, the oxidation reaction of hydrogen (i.e., the fuel) takes places at the anodes, and the reduction reaction of oxygen (supplied by the air) takes places at the cathodes.

Key components of electric vehicle drive systems include the following:
1. High voltage battery with control unit for battery regulation and charger;
2. Electric motor/generator with electronic control (power electronics) and cooling system;
3. Transmission including differential;
4. Brake system (including regenerative braking); and
5. High voltage air conditioning for vehicle interior climate control

In comparison with battery powered EVs, fuel cell powered electric vehicles also have additional components such as a fuel cell stack and a high-pressure hydrogen storage tank.

Generally, electric vehicles may have the following drive combinations.

Electric Vehicle Drive Combinations

| | | | | Range | |
|---|---|---|---|---|---|
| | Full | Plug-in | Battery | Extender | Fuel Cell |
| | Hybrid | Hybrid | Electric | Electric | Electric |
| Drive Train Key | Drive | Drive | Drive | Drive | Drive |
| Components | HEV | PHEV | BEV | RXBEV | FBCEV |
| Internal | Yes | Yes | No | Yes | No |
| Combustion | | | | | |
| Engine | | | | | |
| Electric Motors | Yes | Yes | Yes | Yes | Yes |
| Power | Yes | Yes | Yes | Yes | Yes |
| Electronics | | | | | |
| High Voltage | Yes | Yes | Yes | Yes | Yes |
| Battery | | | | | |
| Charging Contact | No | Yes | Yes | Yes | No |
| for External | | | | | |
| Charging | | | | | |
| Fuel Cell Stack | No | No | No | No | Yes |

Note:
“Yes” indicates that the component is present in the vehicle drive system. “No” indicates that the component is not present in the vehicle drive system.

The common components of the various drive combinations for electric vehicles are electric motors, power electronics, and high voltage battery. The thermal management requirements of the system components are often quite different. For example, lithium-ion batteries are commonly used in electric vehicles. At low temperatures (e.g., below zero degree Celsius), the performance and the range drop significantly due to slower chemical reactions taking place in the battery. At high temperatures (e.g., at above ~40 degree Celsius), the battery deteriorates rapidly. On the other hand, power electronics cannot operate at temperatures higher than 70-80 degree Celsius for a long period of time without significantly reducing service life. Increasing the operating temperature of the magnets in electric motors can also increase the risk of demagnetization of the magnets, which will negatively affect the performance of the electric motors.

In addition, for various electric vehicle (EV) drive system components, the preferred coolant operating temperatures differ, as listed below.
1. High Voltage Lithium Ion Traction Battery: 25 to 35° C. or ambient temperature
2. Power Electronics: 60 to 80° C.
3. Electric Motor: up to 100° C.
4. Fuel Cell Stack: ~80° C.
5. Internal Combustion Engines: 95 to 120° C.

Due to the differing operating temperature requirements of the various components, more than one thermal management fluid circuit is typically required by an electric vehicle.

Effective thermal management of the lithium-ion battery (commonly used in EVs as traction or propulsion high voltage battery) are especially important since it not only impacts the driving range of the EVs, but it also plays a critical role in limiting how quickly that the battery can be recharged at the charging stations. In addition, effective thermal management also helps to increase the service life of the lithium-ion battery.

The majority of electric vehicles on the road today use ethylene glycol-water-based heat transfer fluids to meet its thermal management needs. Some EV models, such as the Nissan Leaf also use air cooling for its high-voltage lithium-ion traction battery system. Using air as heat transfer fluid can simplify the construction of cooling system. However, due to the low heat capacity and low thermal conductivity of air, air cooling is not an effective solution as compared to liquid cooling available in the market. Air cooling requires typically 2 to 3 times more energy to remove heat compared to liquid cooling. Providing uniform and effective cooling of every cell in the battery pack in an EV that may contain many individual cells is very challenging when using air as a heat transfer media.

On the other hand, most of the ethylene glycol-water based heat transfer fluids currently used as thermal management fluids contain corrosion inhibitors and other components that may ionize in aqueous solutions. Hence, these ethylene glycol-water based heat transfer fluids typically have high electrical conductivity in the range of a few thousand μS/cm (microSiemens per centimeter). These heat transfer fluids are designed to be circulating inside cooling plates located adjacent or next to lithium-ion battery cells but are electrically isolated from the high-voltage battery under normal operating conditions.

The only exception is the heat transfer fluids (or coolants) for use in fuel cell stack cooling systems for fuel cell powered electric vehicles. In fuel cell stack cooling systems, the DC voltage up to few volts per centimeter can be experienced by coolant in the fuel cell stack flow channels. To minimize stray current corrosion and to prevent short-circuiting of electric current, electrically non-conductive ethylene glycol-water heat transfer fluids are specified for use in the fuel cell stack cooling systems. Because of glycol degradation and leaching of ionic species from the surfaces of coolant wetted cooling system components, an ion exchange filter containing mixed bed ion exchange resins is often installed in the flow loop of the fuel cell stack cooling system to remove ionic species from the coolant and to keep the electrical conductivity of the coolant from rising beyond the maximum allowable limit.

Recently, to reduce the risk of lithium-ion battery fire due to coolant leaks (because of an accident or other reason), some vehicle original equipment manufacturers (OEMs) use prediluted, ready-to-use low electrical conductivity (i.e., less than 150 μS/cm) ethylene glycol water-based coolants in the battery pack cooling system in some models of battery powered EVs. However, since the electrolytes (e.g., lithium hexafluorophosphate LiPF₆ dissolved in ethylene carbonate) used in lithium-ion batteries are water soluble and the coolant cold plates are designed to be in close contact with the battery pack components, a coolant leak due to an accident (or other reason) may be accompanied with a battery leak. As a result, the electrical conductivity of the leaked coolant may quickly increase after it is mixed with the battery electrolyte and other ionic contaminants in the system, which may result in short circuits among the cell casings, battery module, and/or battery pack metallic walls, and cell terminals. The high electrical current due to the short circuits may lead to a rapid increase in battery temperature that could lead to battery ignition and burning. In fact, vehicle fires initiated from damaged batteries have been reported in EVs using electrically non-conductive (or low electrical conductivity) ethylene glycol-water based coolants in their battery pack cooling systems.

Thus, there is a need for new non-aqueous heat transfer fluid that is electrically non-conductive and effective in minimizing stray current corrosion, and at the same time, has outstanding physical and chemical properties to function as an effective heat transfer fluid, as well as providing corrosion protection of heat transfer components produced by a controlled atmosphere brazing (CAB) process (e.g., automotive heat exchangers), and having low solubility of water and inorganic salts that can be ionized in water.

### SUMMARY

After considerable study, the inventors have discovered that heat transfer fluids that comprise, consist essentially of, or consist of bis(2-ethylhexyl) adipate and one or more electrically non-conductive solvent (or water insoluble) dyes and other optional components for use as a thermal management fluid in electric vehicles are effective. The described heat transfer fluids may also contain one or more optional mono- or di-esters selected from isopropyl oleate, iso-butyl oleate, 2-ethyl hexyl oleate, di(2-ethylhexyl) azelate, di(2-ethylhexyl) sebacate, neopentyl glycol di-heptanoate, neopentyl glycol di-nonanoate, neopentyl glycol di-octanoate, neopentyl glycol di-decanoate, neopentyl glycol 2-ethyl hexanoate, and isopropyl C₁₀ to C₂₄ aliphatic carboxylate, iso-butyl C₁₀ to C₂₄ aliphatic carboxylate, 2-ethyl hexyl C₁₀ to C₂₄ aliphatic carboxylate, and di-(C₃ to C₂₄ branched or straight chain aliphatic carboxylate) adipate, and mixtures or combinations thereof. It is also contemplated any of the described optional mono- or di-esters may be excluded from the described compositions.

Aspects and embodiments of the present invention are set out in the appended claims. These and other aspects and embodiments of the invention are also described herein.

The described heat transfer fluids may also contain one or more optional ingredients selected from antifoams, azole compounds, neutral phosphate esters, neutral alkyl phosphonocarboxylates or alkoxyl phosphonocarboxylates, flame retardants, antioxidants, corrosion inhibitors, anti-wear agents, and other additives, as well as combinations of the described optional ingredients. It is also contemplated any of the described optional one or more optional ingredients may be excluded from the described compositions.

The described heat transfer fluids are non-toxic, readily biodegradable, and have other desirable health, safety, and environmental related properties so that the described heat transfer fluids may be suitable for use as a consumer product.

The described heat transfer fluids may be used as immersion cooling fluids for high voltage batteries (i.e., traction or propulsion battery) or for other electrical drivetrain systems (e.g., gearbox, and integrated gearbox/electric motors, power inverter, on board electric components, charging system for external charging, transmission system, brake system, high voltage air conditioning system for vehicle interior climate control, etc.) in electric vehicles.

Unless otherwise explicitly noted, all percentages in this disclosure refer to a percent by weight.

It is to be understood that elements and features of the various representative embodiments described below may be combined in different ways to produce new embodiments that likewise fall within the scope of the present teachings.

The invention extends to compositions and methods substantially as described herein and/or as illustrated with reference to the accompanying figures. The invention extends to any novel aspects or features described and/or illustrated herein. In addition, composition aspects may be applied to method aspects, and vice versa. Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

### DESCRIPTION OF THE DRAWINGS

The patent or application file contains at least one drawing executed in color. Copies of this patent or patent application publication with color drawing(s) will be provided by the Office upon request and payment of the necessary fee.

The foregoing aspects and many of the attendant advantages of the present technology will become more readily appreciated by reference to the following Description, when taken in conjunction with the accompanying drawings.

FIG. 1 is a Technical Data Sheet for Shell Thermal Fluid E5™ 410

FIG. 2 is a chart that shows that properties of MIVOLT DF7, which is a non-aqueous immersion hear transfer fluid available from M&I Materials Ltd., Manchester, United Kingdom.

FIG. 3 is a chart that shows properties of MIVOLT FF218, which is a non-aqueous immersion hear transfer fluid available from M&I Materials Ltd., Manchester, United Kingdom.

FIG. 4 is a chart that shows properties of MIVOLT DFK, which is a non-aqueous immersion hear transfer fluid available from M&I Materials Ltd., Manchester, United Kingdom.

FIG. 5 is a chart that shows properties of MIVOLT FF316, which is a non-aqueous immersion hear transfer fluid available from M&I Materials Ltd., Manchester, United Kingdom.

FIG. 6 is a chart that shows properties of MIVOLT CL200, which is a non-aqueous immersion hear transfer fluid available from M&I Materials Ltd., Manchester, United Kingdom.

FIG. 7 is a chart that shows properties of MIVOLT CL300, which is a non-aqueous immersion hear transfer fluid available from M&I Materials Ltd., Manchester, United Kingdom.

FIG. 8 is a chart that shows properties of MIDEL En 1215, which is a non-aqueous immersion hear transfer fluid available from M&I Materials Ltd., Manchester, United Kingdom.

FIG. 9 is a chart that shows properties of MIVOLT 7131, which is a non-aqueous immersion hear transfer fluid available from M&I Materials Ltd., Manchester, United Kingdom.

FIG. 10 is product description sheet for Envirotemp™ 360 Fluid, which is a synthetic ester fluid for use in free-breathing transformers and available from Cargill, Incorporated.

FIG. 11 shows a comparison of the ultraviolet-visible (“UV-Vis.”) absorption spectrum for a widely available commercial 50 vol. % aftermarket Long Life coolant solution (diluted after adding an equal volume of deionized water to the aftermarket Long Life Coolant concentrate) before being subjected to the accelerated sunlight weathering exposure storage test described below with the same sample of the widely available commercial 50 vol. % aftermarket Long Life coolant solution (diluted after adding an equal volume of deionized water to the aftermarket Long Life Coolant concentrate) after the accelerated sunlight weathering exposure storage test described below. FIG. 11 also includes photographs of the control sample of the Aftermarket Long life coolant and two samples of the Aftermarket Long Life coolant solution after the Accelerated Sunlight Weathering Exposure storage test (i.e., the exposure tests were repeated for this test coolant solution).

FIG. 12A shows the UV-Vis. absorption spectrum for one embodiment of a heat transfer fluid composition according to the present invention before and after the Accelerated Sunlight Weathering Exposure Storage test described below. The heat transfer composition contained bis(2-ethylhexl) adipate (99% pure, ThermoFisher Scientific Inc., Waltham, MA 02451), and 0.002 wt % of Chromatint Violet X-4109 (Chromatint Violet X-4109 is also known as solvent violet 13, CAS no. 81-48-1).

FIG. 12B is a photo of the pre-test (sample on the left) and post-test heat transfer fluid (i.e., post Accelerated Sunlight Weathering Exposure Storage test, sample on the right).

FIG. 13A shows the UV-Vis. absorption spectrum for one embodiment of a heat transfer fluid composition according to the present invention before and after the Accelerated Sunlight Weathering Exposure Storage test described below. The heat transfer composition contained bis(2-ethylhexl) adipate (99% pure, ThermoFisher Scientific Inc.) and 0.001 wt % of Chromatint Yellow X-4108 (Chromatint Yellow X-4109 is also known as Quinolone Yellow, CAS no. 8003-22-3).

FIG. 13B is a photo of the pre-test (sample on the left) and post-test heat transfer fluid (i.e., post Accelerated Sunlight Weathering Exposure Storage test, sample on the right).

FIG. 14A shows the UV-Vis. absorption spectrum for one embodiment of a heat transfer fluid composition according to the present invention before and after the Accelerated Sunlight Weathering Exposure Storage test described below. The heat transfer composition contained bis(2-ethylhexl) adipate (99% pure, ThermoFisher Scientific Inc.) and 0.002 wt % of Chromatint Yellow X-4108.

FIG. 14B is a photo of the pre-test (sample on the left) and post-test heat transfer fluid (i.e., post Accelerated Sunlight Weathering Exposure Storage test, sample on the right).

FIG. 15A shows the UV-Vis. absorption spectrum for one embodiment of a heat transfer fluid composition according to the present invention before and after the Accelerated Sunlight Weathering Exposure Storage test described below. The heat transfer composition contained bis(2-ethylhexl) adipate (99% pure, ThermoFisher Scientific Inc.) and 0.001 wt % Chromatint Green X-4107 (Chromatint Green X-4107 is also known as Solvent Green 3, CAS no. 128-00-3).

FIG. 15B is a photo of the pre-test (sample on the left) and post-test heat transfer fluid (i.e., post Accelerated Sunlight Weathering Exposure Storage test, sample on the right).

FIG. 16A shows the UV-Vis. absorption spectrum for one embodiment of a heat transfer fluid composition according to the present invention before and after the Accelerated Sunlight Weathering Exposure Storage test described below. The heat transfer composition contained bis(2-ethylhexl) adipate (99% pure ThermoFisher Scientific Inc.) and 0.002 wt % Chromatint Green X-4107.

FIG. 16B is a photo of the pre-test (sample on the left) and post-test heat transfer fluid (i.e., post Accelerated Sunlight Weathering Exposure Storage test, sample on the right).

FIG. 17A shows the UV-Vis. absorption spectrum for one embodiment of a heat transfer fluid composition according to the present invention before and after the Accelerated Sunlight Weathering Exposure Storage test described below. The heat transfer composition contained bis(2-ethylhexl) adipate (99% pure, ThermoFisher Scientific Inc.) and 0.001 wt % Chromatint Blue D55025 (also known as Solvent Blue 35, CAS no. 17354-14-2).

FIG. 17B is a photo of the pre-test (sample on the left) and post-test heat transfer fluid (i.e., post Accelerated Sunlight Weathering Exposure Storage test, sample on the right).

FIG. 18A is a photo of the front side of metal coupons after being tested in a modified ASTM D1384 test (test duration: 336 hours at 88° C.) where bis(2-ethylhexyl) adipate (99% pure, ThermoFisher Scientific Inc.) was used as the test solution without adding any corrosive salt.

FIG. 18B is a photo of the back side of the metal coupons shown in FIG. 13A after being tested in a modified ASTM D1384 test (test duration: 336 hours at 88° C.) where bis(2-ethylhexyl) adipate was used as the test solution without adding any corrosive salt.

FIG. 19A is a photo of the front side of a blank or control set of metal specimens after cleaning per ASTM D1384 specification.

FIG. 19B is a photo of the back side of the blank or control set of metal specimens shown in FIG. 14A, after cleaning per ASTM D1384 specification.

FIG. 20A is a photo of the front side of the metal coupons after being tested in a modified ASTM D1384 test (test duration: 336 hours at 88° C.) where bis(2-ethylhexyl) adipate containing 0.001 wt % D55025 Chromatint Blue was used as the test solution without adding any corrosive salt.

FIG. 20B is a photo of the back side of the metal coupons shown in FIG. 14A after being tested in a modified ASTM D1384 test (test duration: 336 hours at 88° C.) where bis(2-ethylhexyl) adipate containing 0.001 wt % D55025 Chromatint Blue was used as the test solution without adding any corrosive salt.

FIG. 21A is a photo of the front side of the metal coupons after being tested in a modified ASTM D1384 test (test duration: 336 hours at 88° C.) where a commercially available prediluted ready-to-use electrically non-conductive (or very low electrical conductivity) OE battery thermal management system coolant (may be referred to as OE battery thermal management system coolant 1 or OE BEV coolant 1) was used as the test solution without adding any corrosive salt.

FIG. 21B is a photo of the back side of the metal coupons shown in FIG. 15A after being tested in a modified ASTM D1384 test (test duration: 336 hours at 88° C.) where prediluted ready-to-use electrically non-conductive (or very low electrical conductivity) OE battery thermal management system coolant 1 (or OE BEV coolant 1) was used as the test solution without adding any corrosive salt.

FIG. 22A is a photo of the front side of the metal coupons after being tested in a modified ASTM D1384 test (test duration: 336 hours at 88° C.), where a prediluted ready-to-use low electrical conductivity OE BEV coolant 2 was used as the test solution without adding any corrosive salt.

FIG. 22B shows a photo of the back side of the metal coupons shown in FIG. 16A after being tested in a modified ASTM D1384 test (test duration: 336 hours at 88° C.) where prediluted ready-to-use low electrical conductivity OE BEV coolant 2 was used as the test solution without adding any corrosive salt.

FIG. 23 is a photo of post-test radiator cubes after being tested in the radiator cube stagnation tests at 100° C., 140° F., and 100° F., respectively, for two weeks in a heat transfer fluid composition containing bis(2-ethylhexyl) adipate with 0.002 wt % of Chromatint Yellow 4108.

FIG. 24 is a photo of post-test radiator cubes after being tested in the radiator cube stagnation tests at 100° C., 140° F., and 100° F., respectively, for two weeks in a heat transfer fluid composition containing 0.002 wt % of Solvent Green 3 Dye (1,4-bis(p-tolylamino)anthracene-9,10-dione, CAS no. 128-00-3, C₂₈H₂₂N₂O₂, or Quinizarin Green SS, also known as Chromatint Green 4107) and bis(2-ethylhexl) adipate.

FIG. 25A is a photo of post-test radiator cubes after being tested in the radiator cube stagnation tests at 100° C., 140° F., and 100° F., respectively, for two weeks in a heat transfer fluid that is a commercially available prediluted ready-to-use low electrical conductivity and is or may be referred to as OE BEV coolant 2. A new radiator cube (the top left radiator cube in the photo) that was not tested in the radiator cube stagnation test is included in the photo as a control for comparison.

FIG. 25B is a photo of the air-dried deposits collected from filtering the post-test solutions of the radiator cube stagnation tests described with respect to FIG. 25A after conducting the tests for 2 weeks at 100° C., 140°, and 100° F., respectively in a prediluted ready-to-use low electrical conductivity OE BEV coolant 2, where the filtering was conducted using a 0.45 μm filter paper for a post-test solution collected under each test temperature condition.

FIG. 25C is a photo of the air-dry deposits collected from filtering the post-test solution of the radiator cube stagnation test described with respect to FIG. 25A after conducting the test for 2 weeks at 100° C. in the prediluted ready-to-use low electrical conductivity OE BEV coolant 2.

FIG. 26A is a photo of post-test radiator cubes after being tested in the radiator cube stagnation tests at 100° C., 140° F., and 100° F., respectively for 2 weeks in a heat transfer fluid that is 50 vol % of an aftermarket high electrical conductivity EV coolant. This aftermarket coolant is approved by an OE for use as factory fill and service fill coolant for its BEVs and is also approved by several OEs for use as factory fill and service fill coolant for many models of their vehicles powered by an internal combustion engine. For simplicity, this coolant is or may be referred to as OE BEV coolant 3. A new radiator cube (i.e., the top left radiator cube in the photo) is also shown in FIG. 26A for comparison. The 50 vol. % coolant solution was obtained by adding an equal volume of deionized water to the coolant concentrate product.

FIG. 26B is a photo of the air-dried deposits collected from using the first piece of filter paper (two pieces of 0.45 μm filter paper were used to filter the post-test solution for this test condition) to filter about half of the post-test solution of the radiator cube stagnation after conducting the test for 2 weeks at 100° C. in 50 vol % of the aftermarket high electrical conductivity EV coolant (i.e., 50 vol % OE BEV coolant 3).

FIG. 26C is a photo of the air-dried deposits collected from using the second piece of filter paper to filter the remainder of the post-test solution of the radiator cube stagnation after conducting the test for 2 weeks at 100° C. in 50 v % aftermarket high electrical conductivity EV coolant (i.e., 50 vol % OE BEV coolant 3).

FIG. 26D is a photo of the air-dried deposits collected from filtering the post-test solution of the radiator cube stagnation test after conducting the test for 2 weeks at 140° F. in 50 vol. % aftermarket high electrical conductivity coolant (i.e., 50 vol. % OE BEV coolant 3).

FIG. 26E is a photo of the air-dried deposits collected from filtering the post-test solution of the radiator cube stagnation test after conducting the test for 2 weeks at 100° F. in 50 vol. % aftermarket high electrical conductivity coolant (i.e., 50 vol % OE BEV coolant 3).

FIG. 27A shows a photo of post-test radiator cubes after being tested in the radiator cube stagnation tests at 100° C., 140° F., and 100° F., respectively, for two weeks in a heat transfer fluid that is 50 vol. % high electrical conductivity coolant (may be referred to as OE BEV coolant 4).

FIG. 27B is a photo of the air-dried deposits collected from filtering (using a 0.45 μm filter paper for each test temperature) the post-test solutions of the radiator cube stagnation tests after conducting the tests for 2 weeks at 100° C., 140° F., and 100° F. in 50 vol % OE BEV coolant 4.

FIG. 27C is a photo of the air-dried deposits collected from filtering (using a 0.45 μm filter paper for each test temperature) the post-test solutions of the radiator cube stagnation tests after conducting the tests for 2 weeks at 100° C. in 50 vol % OE BEV coolant 4.

FIG. 27D is a photo of the air dried dry deposits collected from filtering (using a 0.45 μm filter paper for each test temperature) the post-test solutions of the radiator cube stagnation tests after conducting the tests for 2 weeks at 140° F. in 50 vol % OE BEV coolant 4.

FIG. 27E is a photo of the air dried deposits collected from filtering (using a 0.45 μm filter paper for each test temperature) the post-test solutions of the radiator cube stagnation tests after conducting the tests for 2 weeks at 100° F. in 50 vol % OE BEV coolant 4.

FIG. 28 shows the results of a galvanic corrosion test for a variety of electric vehicle (EV) coolants where cast aluminum (SAE 329 (B319 or UNS A23190) was used as the anode and the cathode, with 6 cm² exposed electrode surface area, a 5 volt anode-cathode voltage, with an anode-cathode separation distance of 1 cm and conducted at room temperature.

FIG. 29 shows the results of a galvanic corrosion test for a coolant containing 0.002 wt % Solvent Blue and bis(2-ethylhexl) adipate cast aluminum as anode and cathode, with 6 cm² exposed electrode surface area, a 5 volt anode-cathode voltage, with an anode-cathode separation distance of 1 cm and conducted at room temperature.

FIG. 30 shows the results of a galvanic corrosion test for a coolant containing 0.002 wt % D55250 Blue and bis(2-ethylhexl) adipate cast aluminum as anode and cathode, with 6 cm² exposed electrode surface area, a 10 volt anode-cathode voltage, with an anode-cathode separation distance of 1 cm and conducted at room temperature.

### DESCRIPTION

A heat transfer fluid is an electrically non-conductive (or dielectric), colored, heat transfer fluid for use as thermal management fluid in electric vehicle thermal management circuits. The electric vehicle thermal management fluid circuit may contain one or more heat transfer components produced by a controlled atmosphere brazing (CAB) process that uses a fluoride containing flux (or potassium fluoroaluminate flux) to facilitate the joining process of the various aluminum components.

The described heat transfer fluids may be used as dielectric thermal management fluids for immersion and direct cooling of high voltage battery and other electric drivetrain systems (e.g. gearbox, and integrated gearbox/electric motors, power inverter, on board electric components) used in electric vehicles. The described heat transfer fluids may also be used as dielectric thermal management fluids for immersion cooling systems where direct fluid contact with electric parts occurs such as electric vehicle charging stations, high performance computing systems used in data centers, crypto mining, and/or generative AI (artificial intelligent) computing applications.

The described heat transfer fluid includes bis(2-ethylhexyl) adipate and one or more ultraviolet (UV) and sunlight stable, electrically non-conductive solvent (or water-insoluble) dyes or colorants. The described heat transfer fluids may also contain one or more optional mono- or di-esters selecting from isopropyl oleate, iso-butyl oleate, 2-ethyl hexyl oleate, di(2-ethylhexyl) azelate, di(2-ethylhexyl) sebacate, neopentyl glycol di-heptanoate, neopentyl glycol di-nonanoate, neopentyl glycol di-octanoate, neopentyl glycol di-decanoate, neopentyl glycol 2-ethyl hexanoate, and isopropyl C₁₀ to C₂₄ aliphatic carboxylate, iso-butyl C₁₀ to C₂₄ aliphatic carboxylate, 2-ethyl hexyl C₁₀ to C₂₄ aliphatic carboxylate, di-(C₃ to C₂₄ branched or straight chain aliphatic carboxylate) adipate, and combinations thereof. It is also contemplated any of the described optional mono- or di-esters may be excluded from the described compositions.

The described heat transfer fluids may also contain one or more optional ingredients selected from antifoams, azole compounds, neutral phosphate esters (including, but not limited to, tri-alkyl phosphate (tris alkyl phosphate) such as tri-ethyl phosphate, tri-butyl phosphate, tris(2-ethylhexyl) phosphate, and tri-octyl phosphate, or tri-alkoxy phosphate such as tris(2-butoxyethyl) phosphate), neutral alkyl phosphonocarboxylates or alkoxyl phosphonocarboxylates (in which the alkyl or alkoxy group may contain 1 to 20 carbon atoms), flame retardants, antioxidants, corrosion inhibitors, anti-wear agents, and other additives, as well as combinations of the described optional ingredients. It is also contemplated any of the described optional one or more optional ingredients may be excluded from the described compositions.

The heat transfer fluid may also contain one or more optional components selected from one or more optional mono- or di-esters selected from isopropyl oleate, iso-butyl oleate, 2-ethyl hexyl laurate, 2-ethyl hexyl oleate, di(2-ethylhexyl) azelate, di(2-ethylhexyl) sebacate, neopentyl glycol di-heptanoate, neopentyl glycol di-nonanoate, neopentyl glycol di-octanoate, neopentyl glycol di-decanoate, neopentyl glycol 2-ethyl hexanoate, propylene glycol dihexanoate, propylene glycol diheptanoate, propylene glycol dicaprylate, propylene glycol dicaprylate/dicaprate, propylene glycol dinonanoate, propylene glycol diethylhexanoate, propylyene glycol diisononanoate, propylene glycol dicaprate, propylene glycol diperlargonate, propylene glycol laurate, butylene glycol diheptanoate, butylene glycol dicaprylate, butylene glycol dicaprylate/dicaprate, butylene glycol dihexanoate, butylene glycol dinonanoate, butylene glycol diethylhexanoate, butylene glycol diisononanoate, and isopropyl C₁₀ to C₂₄ aliphatic carboxylate, methyl octanoate, methyl nonanoate, methyl decanoate, methyl laurate, methyl oleate, methyl-C₇ to C₂₄ aliphatic carboxylate, iso-butyl C₁₀ to C₂₄ aliphatic carboxylate, 2-ethyl hexyl C₁₀ to C₂₄ aliphatic carboxylate, di-(C₃ to C₂₄ branched or straight chain aliphatic carboxylate) adipate, and combinations thereof. It is also contemplated any of the described optional mono- or di-esters may be excluded from the described compositions.

The heat transfer fluids may include one or more optional components selected from antifoams, azole compounds, neutral phosphate esters (e.g., tri-alkyl phosphate (tris alkyl phosphate) such as tri-ethyl phosphate, tri-butyl phosphate, tris(2-ethylhexyl) phosphate, and tri-octyl phosphate, or tri-alkoxy phosphate such as tris(2-butoxyethyl) phosphate), neutral alkyl phosphonocarboxylates or alkoxyl phosphonocarboxylates (e.g., triethyl phosphonoformate, triethyl phosphonoacetate, trimethyl phosphonoacetate, methyl diethylphosphonoacetate, triethyl 2-phosphonopropionate, triethyl-3-phosphonopropionate, trimethyl-3-phosphonopropionate), antioxidants, corrosion inhibitors, anti-wear agents, and other additives, and combinations thereof.

### Bis(2-ethylhexyl) adipate

Advantageously, it has been found that a heat transfer fluid containing bis(2-ethylhexyl) adipate exhibits desirable properties for use as a base fluid for use as an electrically non-conductive electric vehicle thermal management fluid.

Table 1 provides some physical and other attributes of bis(2-ethylhexyl) adipate. It is evident to the skilled artisan that bis(2-ethylhexyl) adipate has a high boiling point, low freeze point (e.g., low melting point and low pour point), high flash point, low viscosity as compared to other ester-based fluids suitable for use as heat transfer fluid, and attractive thermal properties (e.g., relatively high thermal conductivity and heat capacity). bis(2-ethylhexyl) adipate is also readily available at reasonable cost.

TABLE 1

| ID or Property | Values | |
|---|---|---|
| Name | bis(2-ethylhexyl) adipate | |
| CAS no | 103-23-1 | |
| Molecular | C₂₂H₄₂O₄ | |
| Formula | | |
| Synonyms | Di(2-ethylhexyl) adipate, Diethylhexyl adipate, | |
| | DEHA | |
| Molecular weight | 370.6 | g/mol |
| Canonical Smiles | CCCCC(CC)COC(═O)CCCCC(═O)OCC(CC)CCCC | |
| Color/Form | Colorless or very pale amber liquid | |
| Boiling Point | 783° F. at 760 mm Hg; 417.0° C. | |
| Melting Point | −90° F.; −67.8° C. | |
| Flash point | 204.4° C. (400° F.); or 402° F. (206° C.) (open cup); | |
| Solubility | 0.78 mg/l at 22° C. in water | |
| | Sol in most org solvents; Insol. Or very slightly sol. | |
| | in glycerine & glycols. Soluble in ethanol, ethyl | |
| | ether, acetone, and acetic acid. | |
| Density | 0.923; or 0.922 @ 25° C. / 4° C. | |
| Vapor pressure | less than 0.01 mm Hg at 68° F.; | |
| | 2.6 mm at 392° F. | |
| | 8.5 × 10⁻⁷ mm Hg at 20° C. | |
| | 2.4 mm Hg @ 200° C. | |
| Autoignition | 710° F. | (377° C.) |
| Temperature | | |
| Fire point | 430° | F. |
| Viscosity | 13.7 cP @ 20° C. | |
| | 12.3 mm²/s (cSt) at 25° C. | |
| | 8.87 cSt at 35° C. | |
| | 260 cSt at −20° F. (or −28.9° C.) | |
| pH | Acidity: 0.25 (meg/100 gm. Max) | |
| Refractive Index | 1.4474 @ 20° C. | |
| Pour Point | −75° | C. |
| Melting Point | −67.8° C. or −90° F. | |
| wt/gal | 7.72 lb | (20° C.) |
| Heat capacity | 701.50 | J/Mol*K |
| Cp at 300K | | |
| Thermal | 0.143 | W/(m²* ° C.) |
| conductivity | | |
| Heat capacity | 1.81 × 10⁶ | J/(m³ ° C.) |
| ρCₚ₀ | | |

The heat transfer fluid may include bis(2-ethylhexyl) adipate in amounts from about 0.1% to about 99.9999%. In this regard, the heat transfer fluid may include bis(2-ethylhexyl) adipate in amounts greater than or equal to about 1%, or greater than 5%, 10%, 15%, 20%, 25%, 30%, 35%, 40%, 45%, 50%, 55%, 60%, 65%, 70%, 75%, 80%, 85%, 90%, 95%, 96%, 97%, 98%, 99%, 99.9%, 99.99%, or about 99.999%. It is also contemplated that the heat transfer fluid may include bis(2-ethylhexyl) adipate within any range that may be created from the preceding values. As an example, the heat transfer fluid may include bis(2-ethylhexyl) adipate in an amount from about 90% to about 99.999%, or from about 91% to about 99.999%, or from about 92% to about 99.999%, from about 93% to about 99.999%, or from about 94% to about 99.999%, or from about 95% to about 99.999%, or from about 96% to about 99.999%, or from about 97% to about 99.999%, or from about 98% to about 99.999%, or from about 99% to about 99.999%, or from about 99.9% to about 99.999%.

In some embodiments, the electrically non-conductive non-aqueous heat transfer fluids may include, in addition to the bis(2-ethylhexyl) adipate, one or more mono- or di-esters selected from isopropyl oleate, iso-butyl oleate, 2-ethyl hexyl laurate, 2-ethyl hexyl oleate, di(2-ethylhexyl) azelate, di(2-ethylhexyl) sebacate, neopentyl glycol di-heptanoate, neopentyl glycol di-nonanoate, neopentyl glycol di-octanoate, neopentyl glycol di-decanoate, neopentyl glycol 2-ethyl hexanoate, propylene glycol dihexanoate, propylene glycol diheptanoate, propylene glycol dicaprylate, propylene glycol dicaprylate/dicaprate, propylene glycol dinonanoate, propylene glycol diethylhexanoate, propylyene glycol diisononanoate, propylene glycol dicaprate, propylene glycol diperlargonate, propylene glycol laurate, butylene glycol diheptanoate, butylene glycol dicaprylate, butylene glycol dicaprylate/dicaprate, butylene glycol dihexanoate, butylene glycol dinonanoate, butylene glycol diethylhexanoate, butylene glycol diisononanoate, diethylene glycol diethylhexanoate, propanediol diethylhexanoate, propanediol dicaprylate, propanediol diheptanoate, propanediol dicaprate, propanediol dinonanoate, and isopropyl C₁₀ to C₂₄ aliphatic carboxylate, methyl octanoate, methyl nonanoate, methyl decanoate, methyl laurate, methyl oleate, methyl-C₇ to C24 aliphatic carboxylate, iso-butyl C₁₀ to C₂₄ aliphatic carboxylate, 2-ethyl hexyl C₁₀ to C₂₄ aliphatic carboxylate, di-(C₃ to C₂₄ branched or straight chain aliphatic carboxylate) adipate, and combinations thereof. In this regard, it is also contemplated that electrically non-conductive non-aqueous heat transfer fluids that include bis(2-ethylhexyl) adipate may exclude any one of the above-noted mono- or di-esters.

### Dyes or Colorants

In some instances, the heat transfer fluid is a colored, electrically non-conductive, composition for use as an electric vehicle thermal management fluid. In this instance, the heat transfer fluid includes bis(2-ethylhexyl) adipate or di(2-ethylhexyl) adipate and one or more electrically non-conductive or low electrical conductivity solvent colorants or solvent dyes (or water insoluble colorants).

In one embodiment, the electrically non-conductive colorant will comprise at least one of the following chromophores: anthraquinone, triphenylmethane, diphenylmethane, triarylmethane, diarylmethane, azo containing compounds, disazo (or bishydrazone) containing compounds, trisazo containing compounds, diazo containing compounds, xanthene, acridine, indene, thiazole, two or more conjugated aromatic groups, two or more conjugated heterocyclic groups (e.g., stilbene, and/or pyrazoline, and/or coumarine type radicals or combinations thereof), three or more conjugated carbon-carbon double bonds (e.g., carotene), and combinations thereof.

In one exemplary embodiment, the chromophore contained in the colorant will include one of the following or their combination: triphenylmethane, diphenylmethane, triarylmethane, diarylmethane, and azo containing radical. In another embodiment, the non-conductive colorant will contain aliphatic or aromatic group or their combination thereof, and at least one chromophore such as the ones described above. In some embodiments, the electrically non-conductive or low electrical conductivity solvent colorant may be selected from quinolone yellow solvent dye or solvent green dye 3, or combinations thereof.

In some embodiments, the electrically non-conductive or low electrical conductivity solvent dyes or colorants suitable for use can be one or more selected from the following solvent dyes, quinolone yellow (or solvent yellow 33, C₁₈H₁₁NO₂, 2-quinolin-2-ylindene-1,3-dione, CAS no. 8003-22-3), solvent green 3 [1,4-bis(p-tolylamino)anthracene-9,10-dione, CAS no. 128-00-3, C₂₈H₂₂N₂O₂, or Quinizarin Green SS], solvent blue 35 (or Sudan Blue II, 1,4-bis(butylamino)anthracene-9,10-dione, C₂₂H₂₆N₂O₂, CAS no. 17354-14-2), solvent yellow 2 (4-dimethylaminoazobenzene, CAS no. 60-11-7, C₁₄H₁₅N₃), solvent yellow 14 or Sudan I (1-phenylazo-2-naphthol, CAS. no. 842-07-9, C₁₆H₁₂N₂O), solvent yellow 16 (4-benzeneazo-3-methyl-1-phenyl-5-pyrazolone, CAS no. 4314-14-1, C₁₆H₁₄N₄O), solvent yellow 18 (3-phenylazo-2,4-dihydroxy-quinoline, CAS no. 6407-80-3, C₁₅H₁₁N₃O), solvent yellow 43 (2-butyl-6-(butylamino)-1H-benzo(de)isoquinoline-1,3(2H)-dione, CAS no. 19125-99-6, C₂₀H₂₄N₂O), solvent yellow 44 (4-amino-N-2,4-xylyl-1,8-naphthalimide, CAS no. 144246-02-6, C₂₀H₁₆N₂O₂), solvent yellow 56 (N,N-diethyl-4-phenyldiazenylaniline, CAS No. 2481-94-9, C₁₆H₁₉N₃), solvent yellow 58 (N,N-bis(2-hydroxyethyl)hexanediamide, CAS no. 1964-73-4, C₁₀H₂₀N₂O₄), solvent yellow 72 (4-[(2-methoxyphenyl)diazenyl]-5-methyl-2-phenyl-4H-pyrazol-3-one, CAS no. 4645-07-2, C₁₇H₁₆N₄O₂), solvent yellow 163 (1,8-bis(phenylthio)-9,10-anthracenedione, CAS no. 13676-91-0, C₂₆H₁₆O₂S₂), solvent violet 8 ([4-[4,4′-bis(dimethylamino)benzhydrylidene]cyclohexa-2,5-dien-1-ylidene]methylamine, CAS no. 52080-58-7, C₂₄H₂₅N₃), solvent violet 9 (tris[4-(dimethylamino)phenyl]methanol, CAS no. 467-63-0, C₂₅H₃₁N₃O), solvent violet 13 (1-hydroxy-4-(p-toluidino)anthraquinone, C₂₁H₁₅NO₃, CAS no. 81-48-1), solvent violet 14 (1,5-bis[(4-methylphenyl) amino]-9,10-anthracenedione, C₂₈H₂₂N₂O₂, CAS no. 67577-84-8), solvent violet 31 (1,4-diamino-2,3-dichloroanthracene-9,10-dione, CAS no. 70956-27-3, C₁₄H₈Cl₂N₂O₂), solvent violet 38 (1,4-bis[(2,6-dibromo-4-methylphenyl)amino]-9,10-anthraquinone, CAS no. 63512-14-1, C₂₈H₁₈Br₄N₂O₂), solvent violet 48 (1,8-bis-(4-dodecylanilino)-anthracene-9,10-dione;9,10-Anthracenedione, CAS no. 42887-23-0, C₅₀H₆₆N₂O₂), solvent blue 4 ([4-(anilino)naphthalen-1-yl]-bis[4-(dimethylamino)phenyl]methanol, CAS no. 6786-83-0, C₃₃H₃₃N₃O), solvent blue 5 (bis[4-(diethylamino)phenyl]-[4-(ethylamino)naphthalen-1-yl]methanol, CAS no. 1325-86-6, C₃₃H₄₁N₃O), solvent blue 14 (1,4-bis(pentylamino)anthracene-9,10-dione, oil blue N, CAS No. 2646-15-3, C₂₄H₃₀N₂O₂), solvent blue 16 (CAS no. 12677-19-9, solvent blue 19 (1-(Methylamino)-4-(phenylamino)anthracene-9,10-dione, CAS no. 12769-16-3, C₂₁H₁₆N₂O₂), solvent blue 36 (1,4-bis(isopropylamino)anthracene-9,10-dione, CAS no. 14233-37-5, C₂₀H₂₂N₂O₂), solvent blue 63 (1-(methylamino)-4-[(3-methylphenyl)amino]anthraquinone, CAS no. 6408-50-0, C₂₂H₁₈N₂O₂), solvent green 5 (Diisobutyl 3,9-perylenedicarboxylate, CAS no. 2744-50-5, C₃₀H₂₈O₄), solvent green 28 (1,4-bis(4-butylanilino)-5,8-dihydroxyanthraquinone, CAS no. 28198-05-02, C₃₄H₃₄N₂O₄), solvent orange 2 (1-(o-Tolylazo)-2-naphthol, CAS no. 2646-17-5, C₁₇H₁₄N₂O), solvent red 2 (4-[(2-methylphenyl)diazenyl]naphthalen-1-ol, CAS no. 5098-94-2, C₁₇H₁₄N₂O), solvent red 26 (1-[[2,5-dimethyl-4-[(2-methylphenyl)azo]-phenyl]azo]-2-naphthol, CAS no. 4477-79-6, C₂₅H₂₂N₄O), solvent red 27 (1-(2,5-dimethyl-4-(2,5-dimethylphenyl) phenyldiazenyl) azonapthalen-2-ol, CAS no. 1320-06-5, C₂₆H₂₄N₄O), solvent red 49 (3′,6′-bis(diethylamino)spiro[isobenzofuran-1(3H),9′-[9H]xanthene]-3-one, CAS no. 509-34-2, C₂₈H₃₀N₂O₃), and solvent red 80 (1-((2,5-Dimethoxyphenyl)azo)-2-naphthalenol, citrus red 2, CAS no. 6358-53-8, C₁₈H₁₆N₂O₃).

In some embodiments, the electrically non-conductive or low electrical conductivity solvent dyes or colorants for use in the electrically non-conductive non-aqueous heat transfer fluids may be selected from quinolone yellow (or solvent yellow 33, C₁₈H₁₁NO₂, 2-quinolin-2-ylindene-1,3-dione, CAS no. 8003-22-3), solvent green 3 [1,4-bis(p-tolylamino)anthracene-9,10-dione, CAS no. 128-00-3, C₂₃H₂₂N₂O₂, or Quinizarin Green SS], solvent violet 13 (or 1-hydroxy-4-(4-methylanilino)anthracene-9,10-dione, CAS no. 81-48-1, C₂₁H₁₈NO₃), solvent blue 35 (or Sudan Blue II, 1,4-bis(butylamino)anthracene-9,10-dione, C₂₂H₂₆N₂O₂, CAS no. 17354-14-2), and combinations thereof.

In some embodiments, the electrically non-conductive or low electrical conductivity solvent dyes or colorants for use in the electrically non-conductive non-aqueous heat transfer fluids are UV and/or sunlight stable. In some embodiments, the electrically non-conductive or low electrical conductivity solvent dyes or colorants for use in the electrically non-conductive non-aqueous heat transfer fluids are stable (i.e., the color of the heat transfer fluid will not fade) after exposing to aluminum alloy heat exchanger surfaces containing potassium fluoroaluminate flux residues under electrical vehicle thermal management system operating conditions.

It is also contemplated that the heat transfer fluid will specifically exclude one or more of the above-described non-conductive colorants or dyes.

### Neutral Phosphate Esters

In some embodiments, the electrically non-conductive non-aqueous heat transfer fluid may optionally contain one or more neutral phosphate esters. The neutral phosphate esters suitable for use in the electrically non-conductive non-aqueous heat transfer fluid have the following general structure:

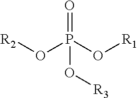

where R₁, R₂, and R₃ are the same or different, are selected from C₂ to C₁₄ alkyl, alkoxy, aryl, or C₇ to C₁₉ alkylaryl groups.

In one embodiment, the neutral phosphate ester that may be used in the electrically non-conductive non-aqueous heat transfer fluid may be selected from triethyl phosphate, tri-propyl phosphate, tributyl phosphate, tri-n-butyl phosphate, triisobutyl phosphate, tributoxyethyl phosphate, tris(2-butoxyethyl) phosphate, tri-2-ethylhexyl phosphate, tri-n-octyl phosphate, dibutyl phenyl phosphate, 2-ethylhexyl diphenyl phosphate, isodecyl diphenyl phosphate, cresyl diphenyl phosphate, triphenyl phosphate, tricresyl phosphate, and combinations thereof.

The inclusion of the described neutral phosphate ester in electrically non-conductive non-aqueous heat transfer compositions may provide improved corrosion protection to the metallic components in the thermal management systems, particularly in cases where an aluminum heat exchanger manufactured by the controlled atmosphere brazing process is included in the flow circuit of the thermal management fluid. In addition to acting as a corrosion inhibitor in the electrically non-conductive non-aqueous heat transfer fluids, the presence of neutral phosphate esters in the heat transfer fluids may also improve fire (or flame) resistance of the fluids. This may lead to improvement in the fire safety of the thermal management fluid system of the electric vehicle, particularly in those instances where the electric vehicle is involved in a collision accident that may result in a leakage of the thermal management fluid. It is also contemplated that the electrically non-conductive non-aqueous heat transfer fluid may exclude such neutral phosphate esters.

The electrically non-conductive, non-aqueous heat transfer fluids may contain one or more optional components selecting from antifoams, antioxidants, corrosion inhibitors, anti-wear agents, acid control additives, viscosity improving agents, azole compounds, and other additives.

### Comparative Non-Aqueous Immersion Heat Transfer Fluids

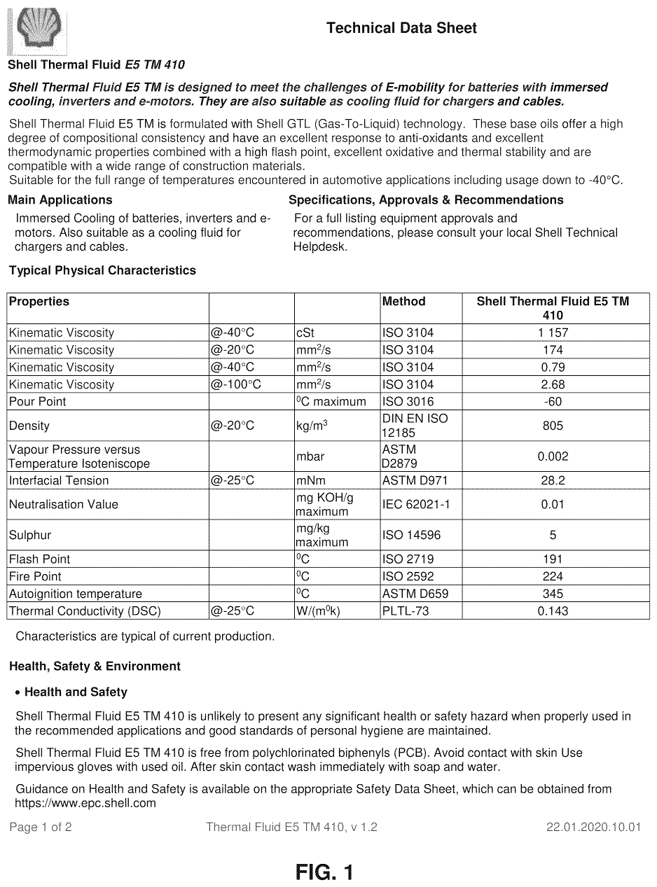

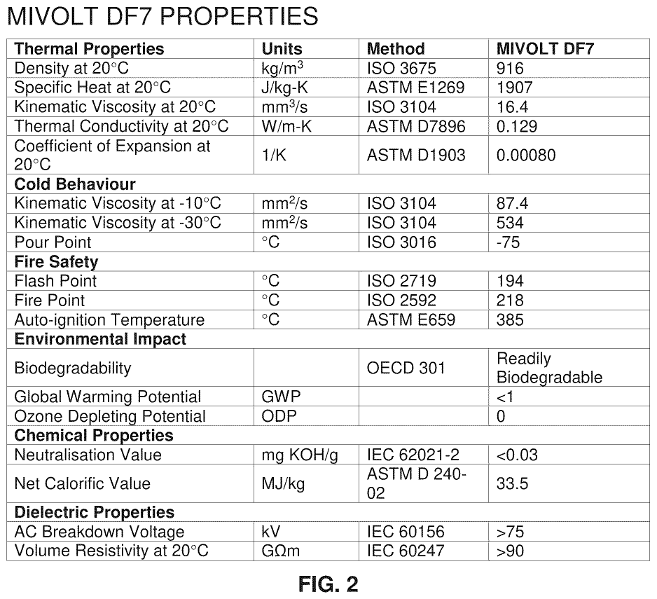

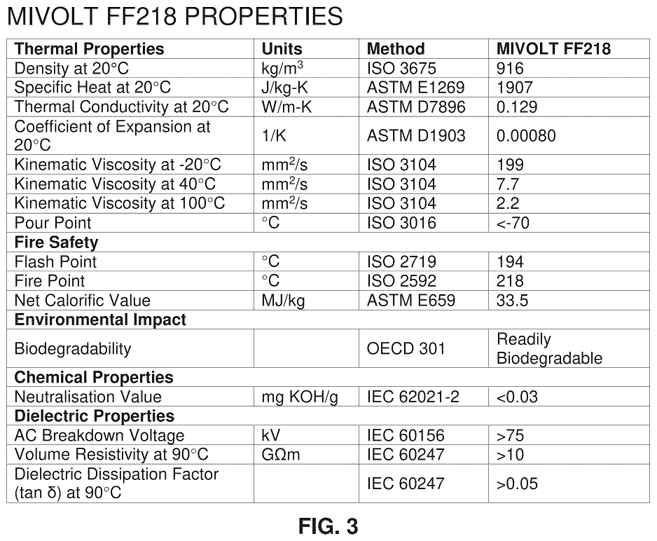

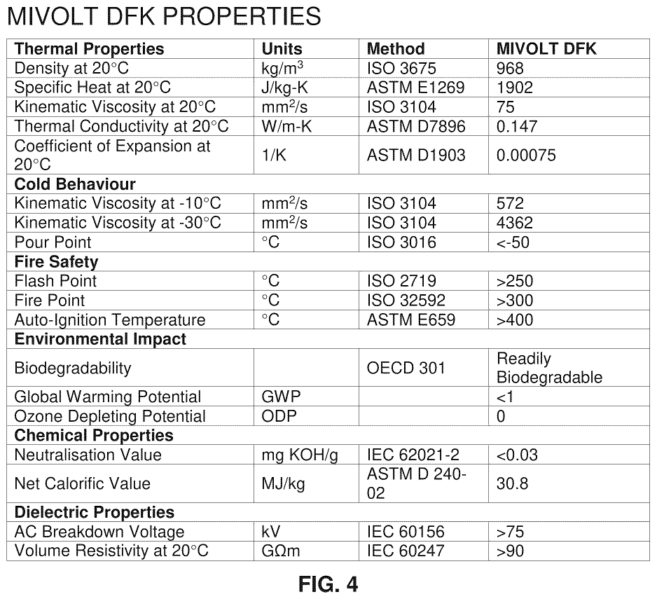

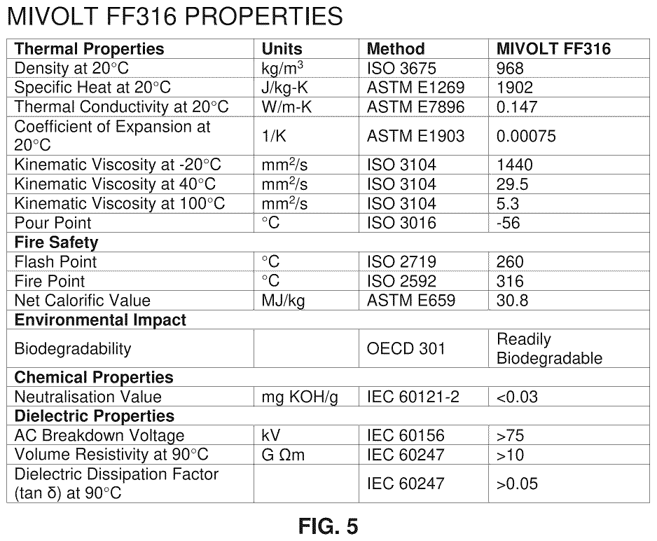

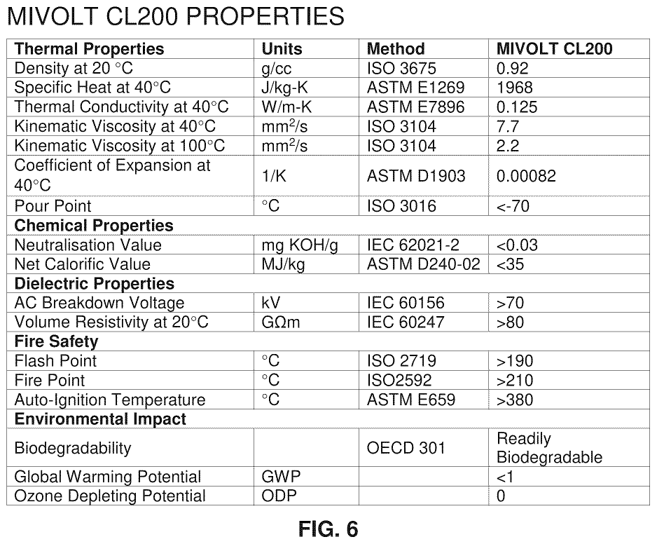

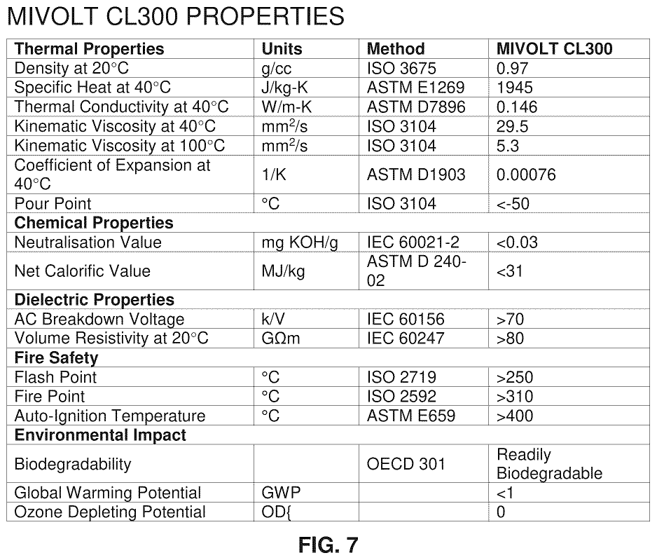

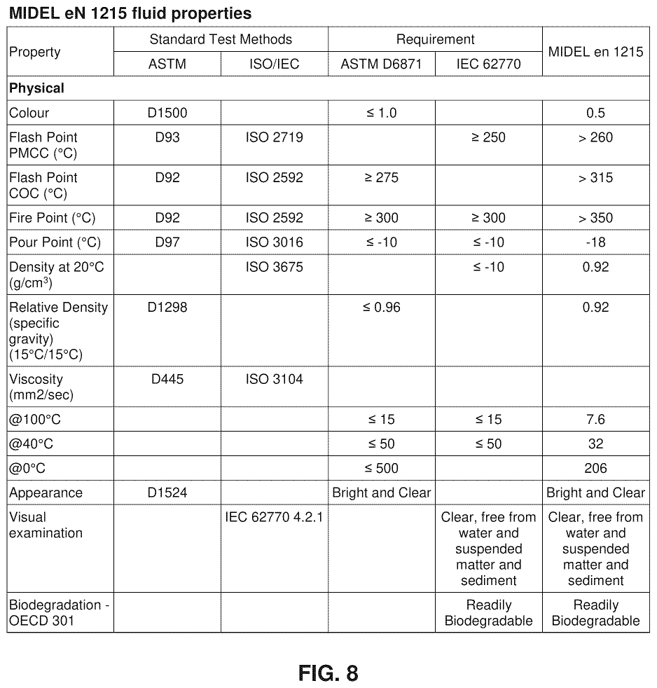

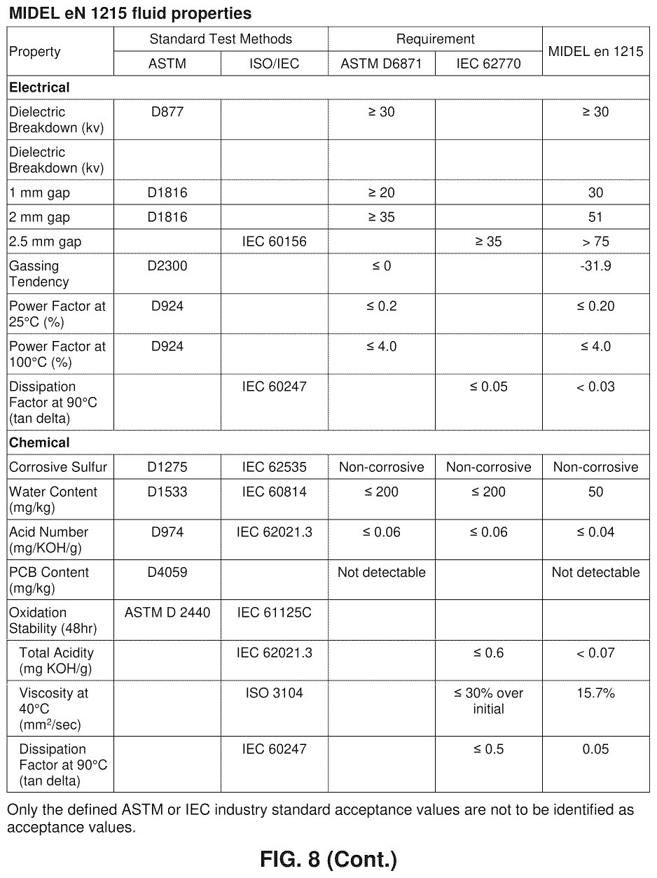

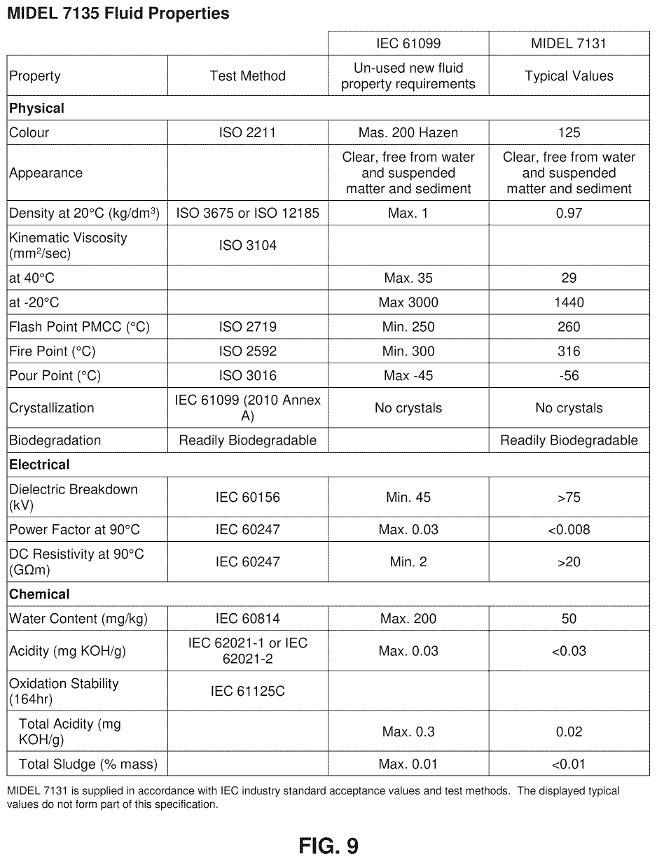

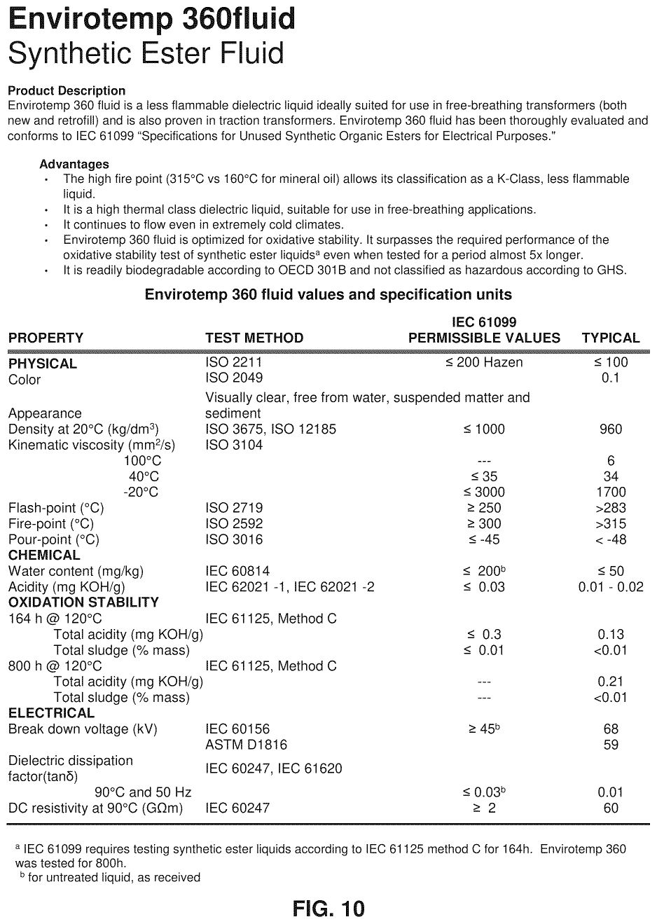

Comparative non-aqueous immersion heat transfer fluids are presented in FIGS. 1-9. Yet another comparative product is provided by Cargill and sold as Envirotemp™ 360 fluid, the properties, for which are shown in FIG. 10. Other comparative non-aqueous immersion hear transfer fluids are available from M&I Materials Ltd. Manchester, United Kingdom and sold under the tradenames MIVOLT DF7, MIVOLT FF218, MIVOLT DFK, MIVOLT FF316, MIVOLT CL200, MIVOLT CL300, MIDEL eN 1215, MIDEL 7131, at least some of which are present in FIGS. 1-9.

Another exemplary comparative non-aqueous immersion heat transfer fluid is AmpCool AC-100 Coolant and it has the properties shown below in Table 2.

TABLE 2
Characteristics of AmpCool AC-100 Coolant

| Product ID | AC-100 |
|---|---|
| Applications | Stationary and vehicular |
| | battery cooling |
| ISO 4460 Particle Count (Avg.) | 10/10/2012 |
| Appearance | Clear |
| Refractive Index nD20 | 1.462 |
| Dielectric Constant | 2.3 |
| Dielectric Strength, kV | >60 kV |
| Resistivity (ohm-cm) | >1 × 10¹⁴ |
| Pour Point (° C.) | −55 |
| Flash Point (° C.) | 180 |
| Density, g/cc @ 16° C. | 0.8113 |
| Coefficient of Thermal | 0.00068 |
| Expansion, vol./° C. | |
| Viscosity (cSt) @ 40° C. | 9.58 |
| Viscosity (cSt) @ 100° C. | 2.68 |
| Thermal Conductivity | 0.1373 |
| (W/m*K) @ 40° C. | |
| Specific Heat (kJ/kg*C) @ 40° C. | 2.2032 |
| Biodegradability (28 Days) | >96% |
| Global Warming Potential | 0 |

### EXAMPLES

The invention will now be further elucidated with reference to the following examples, which should be understood to be non-limitative. It should be appreciated by those of ordinary skill in the art that the techniques disclosed in the examples that follow represent ones discovered by the inventors to function well in the practice of the invention and thus, constitute exemplary modes. One of ordinary skill in the art, when viewing this disclosure, will appreciate that many changes can be made in the specific embodiments while still obtaining similar or like results without departing from the spirit and scope of the present invention.

### Accelerated Sunlight Weathering Exposure Storage Test

To demonstrate the stability of dyes in the described heat transfer fluids, an accelerated sunlight weathering exposure storage test was conducted according to the following procedure. A heat transfer fluid was prepared, and an aliquot was designated as a control. The absorption spectrum of the control from about 375 nm to about 900 nm was measured using an ultraviolet-visible (UV-Vis) spectrometer and plotted.

An aliquot of the prepared heat transfer fluid was inserted into a tightly closed glass bottle, designated as the test composition, and was subjected to artificial sunlight using an Atlas SUNTEST XLS+, weathering instrument (ATLAS Material Testing Technology, IL, USA) equipped with a 2200-watt Xenon lamp and UV special glass daylight filter (for use to yield the more severe D65 exposure condition) at room temperature (typical test chamber air temperature is in the range of ca. 30° C.) for 24 hours. This test may be used to evaluate the photostability of the colorants in the heat transfer fluid or the photostability of the colored heat transfer fluids selected for testing. The 24 hours exposure in the test chamber is equivalent to exposing the test sample for 2 years in direct sunlight. After the 24 hour exposure test, the test sample was visually inspected to see if there was a visible change in the color of the heat transfer fluid solution in comparison with a fresh heat transfer fluid sample (or control sample), i.e., a sample that was not tested in the weathering instrument. UV-Vis absorption spectroscopic measurements on the post-weathering-test sample and the comparable fresh heat transfer fluid sample were used to quantitatively demonstrate whether a significant change in the color of heat transfer fluid after being tested in the Accelerated Sunlight Weathering Exposure instrument occurred. The results obtained from visual inspection of the test samples and the UV-Vis absorption spectrum measurements were used to determine whether the heat transfer fluids tested have sufficient desirable photostability after exposing artificial sunlight for the test duration selected.

### Example 1

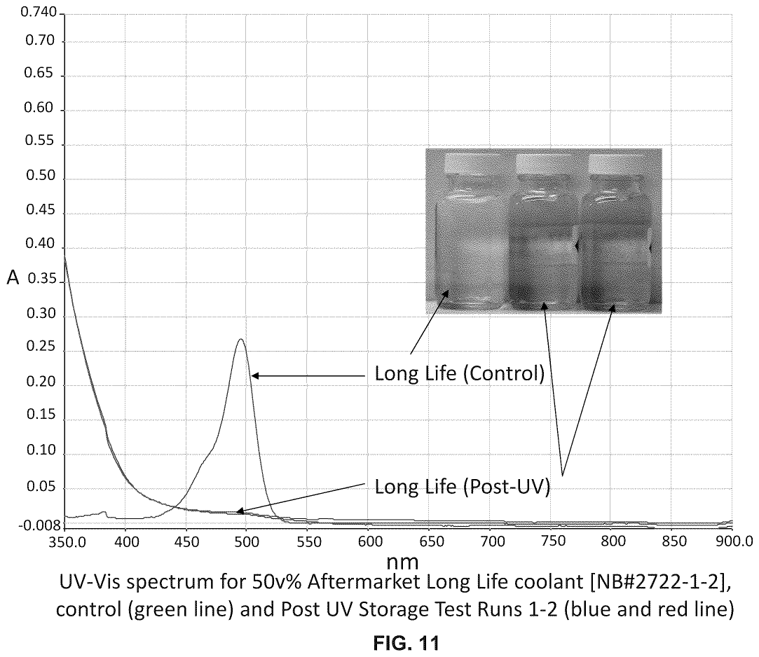

A comparative heat transfer composition containing 50 vol. % of an Aftermarket Long Life coolant was prepared. This Aftermarket Long Life coolant is a widely available commercial product for use as engine coolant for light duty vehicles powered by an internal combustion engine. FIG. 11 shows the UV-Vis absorption spectrum (i.e., the green line) of the control sample (i.e., the fresh 50 vol. % Aftermarket Long Life Coolant solution which was not tested according to the above-described Accelerated Sunlight Weathering Exposure storage test). It is evident that there is a peak at about 490 nm, which indicates the presence of a colorant comprised of fluorescein. FIG. 11 also shows the UV-Vis absorption spectrum of the same 50 vol. % Aftermarket Long Life Coolant after being tested in the Accelerated Sunlight Weathering Exposure Storage test for 24 hours. This test for the 50 vol. % Aftermarket Long Life Coolant solution was repeated. It can be seen from FIG. 11 that the UV-Vis spectrum for each of the tested 50 vol. % Aftermarket Long Life Coolant solution were nearly identical (note the overlapping blue and red lines).

An embedded photograph of the control sample (the sample on the left) and the two post Accelerated Sunlight Weathering Exposure Storage test samples of the 50 vol. % Aftermarket Long Life coolant solution are also shown in FIG. 11. It is apparent that the characteristic fluorescent yellow-green color of the 50 vol. % Aftermarket Long Life Coolant in the control sample is not present or visible in the two post-test samples, which is in agreement with the UV-Vis spectra results shown in FIG. 11, where the 490 nm peak present in the control sample is not present in the UV-Vis absorption spectra of the two post-test samples.

### Example 2

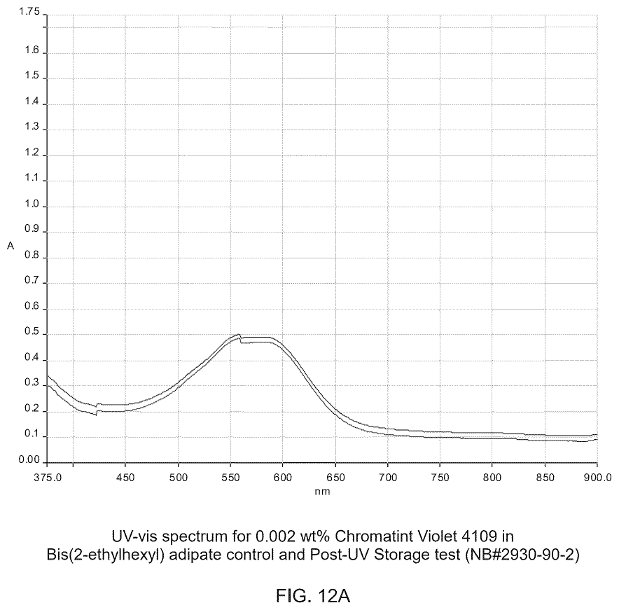

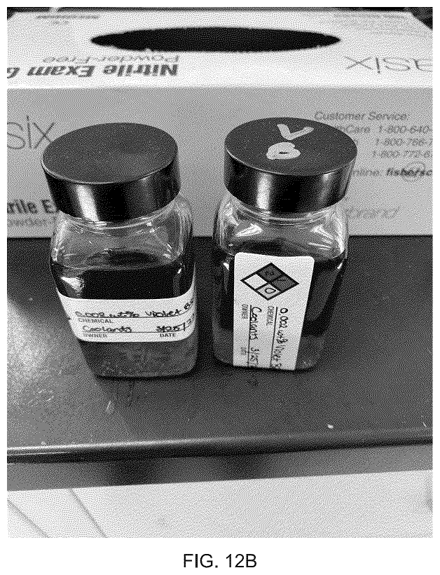

A heat transfer fluid according to described embodiments and containing bis(2-ethylhexyl) adipate and 0.002 wt % Chromatint Violet X-4109 was subjected to the above-described Accelerated Sunlight Weathering Exposure storage test. The UV-Vis absorption spectrums of the pre-test and post-test fluids are shown in FIG. 12A. It is apparent that the peak in the control sample that is present between about 550-600 nm is also present in the tested sample, which indicates that the dye is stable in the described heat transfer fluid under the Accelerated Sunlight Weather Exposure storage test conditions used.

FIG. 12B is a photo of the pre-test (sample on the left) and post-test heat transfer fluid (i.e., post Accelerated Sunlight Weathering Exposure Storage test, sample on the right). It shows that there is no visible color change in the post-test sample, which indicates that the heat transfer fluid bis(2-ethylhexyl) adipate with 0.002 wt % Chromatint Violet 4109 is color stable under the Accelerated Sunlight Weathering Exposure Storage test conditions and which is in agreement with the UV-Vis absorption spectra results shown in FIG. 12A.

### Example 3

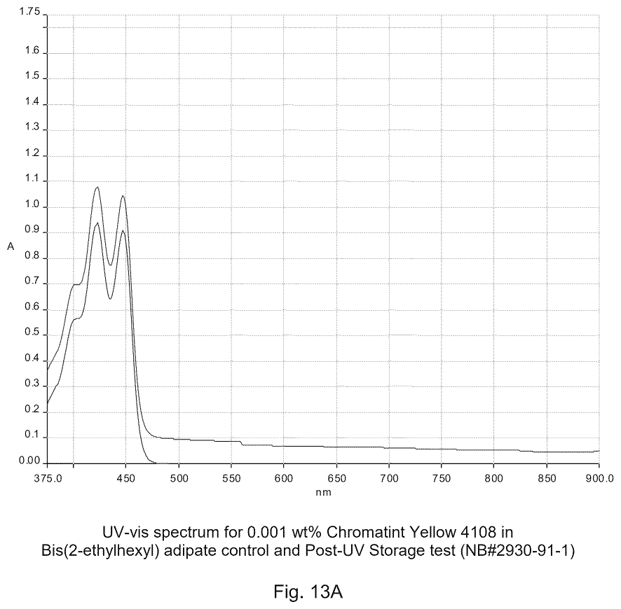

A heat transfer fluid according to described embodiments and containing bis(2-ethylhexyl) adipate and 0.001 wt % Chromatint Yellow X-4108 was subjected to the above-described Accelerated Sunlight Weathering Exposure Storage test. The UV-Vis. absorption spectrums are shown in FIG. 13A and it is apparent that the two peaks in the control sample that are present between about 400-450 nm are also present in the tested sample, which indicates that the dye is generally stable in the described heat transfer fluid, although the UV-Vis absorption peaks were about 20% less in the post-test sample as compared to the absorbance peaks in the pre-test sample.

FIG. 13B is a photo of the pre-test (sample on the left) and post-test heat transfer fluid (i.e., post Accelerated Sunlight Weathering Exposure Storage test, sample on the right). As shown in the photo, there is little to no visible change in the color of the post-test sample in comparison with the pre-test sample, indicating that the heat transfer fluid bis(2-ethylhexyl) adipate+0.001 wt % Chromatint Yellow 4108 is color stable under the Accelerated Sunlight Weather Exposure Storage test conditions used, which is in general agreement with the UV-Vis absorption spectra results shown in FIG. 13A.

### Example 4

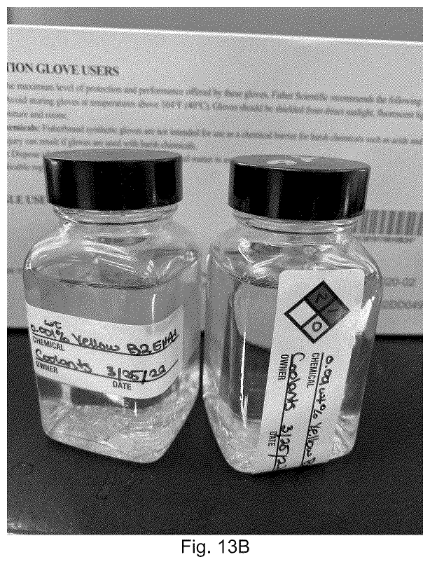

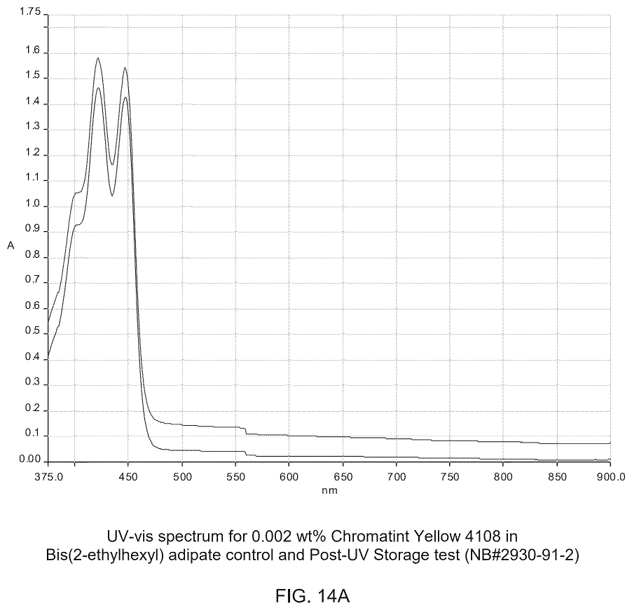

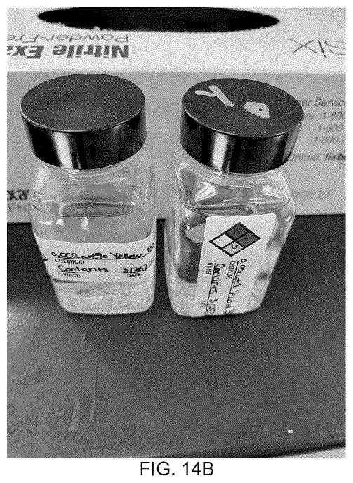

A heat transfer fluid according to described embodiments and containing bis(2-ethylhexyl) adipate and 0.002 wt % Chromatint Yellow X-4108 was subjected to the above-described Accelerated Sunlight Weathering Exposure storage test. The absorption spectrums for both the pre-test and post-test fluids are shown in FIG. 14A. It is apparent that the two peaks in the control sample that are present between about 400-450 nm are also present in the tested sample, which indicates that the dye is stable in the described heat transfer fluid, although the UV-Vis absorption peaks were slightly 20% less (i.e., by ~10%) in the post-test sample as compared to the absorbance peaks in the pre-test sample.

FIG. 14B is a photo of the pre-test (sample on the left) and post-test heat transfer fluid (i.e., post Accelerated Sunlight Weathering Exposure Storage test, sample on the right). As shown in the photo, the pre-test (sample on the left) and post-test sample (sample on the right), there is little visible change in the color of the post-test heat transfer fluid sample in comparison with the pre-test sample, indicating that the heat transfer fluid bis(2-ethylhexyl) adipate containing 0.002 wt % Chromatint Yellow 4108 is color stable under the Accelerated Sunlight Weathering Exposure storage test conditions used, which is in general agreement with the UV-Vis absorption spectrum results shown in FIG. 14A.

### Example 5

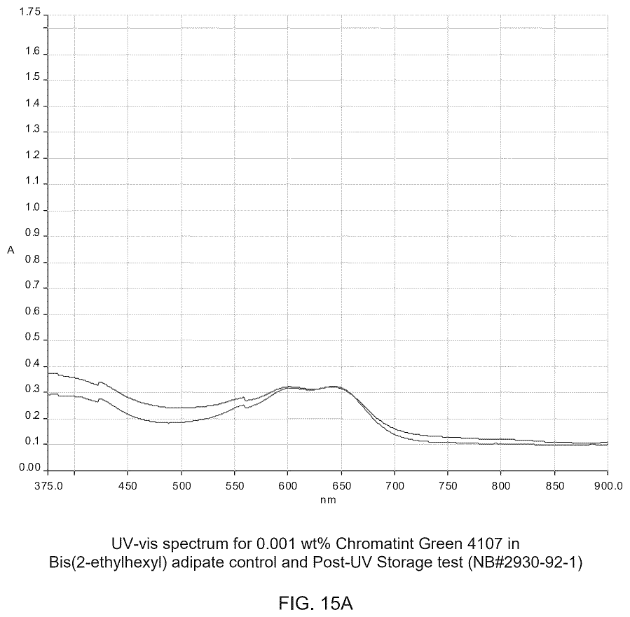

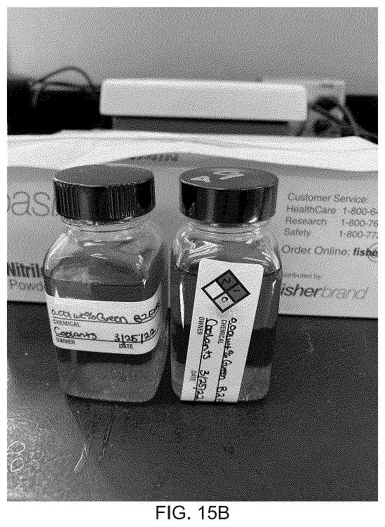

A heat transfer fluid according to described embodiments and containing bis(2-ethylhexyl) adipate and 0.001 wt % Chromatint Green X-4107 was subjected to the above-described Accelerated Sunlight Weathering Exposure storage test. The absorption spectrums for the pre-test (or control) and post-test fluid samples are shown in FIG. 15A. It is apparent that the peak in the control sample that is present between about 550-650 nm is also present in the tested sample, which indicates that the dye is stable in the described heat transfer fluid.

FIG. 15B is a photo of the pre-test (sample on the left) and post-test heat transfer fluid (i.e., post Accelerated Sunlight Weathering Exposure Storage test, sample on the right). As shown in the photo of the pre-test (sample on the left, control sample) and the post-test sample (sample on the right), there is little visible change in the color of the post-test sample in comparison with the pre-test sample, indicating that the heat transfer fluid bis(2-ethylhexyl) adipate containing 0.001 wt % Chromatint Green X-4107 is color stable under the Accelerated Sunlight weathering Exposure Storage test conditions used, which is in agreement with the UV-Vis absorption spectrum results shown in FIG. 15A.

### Example 6

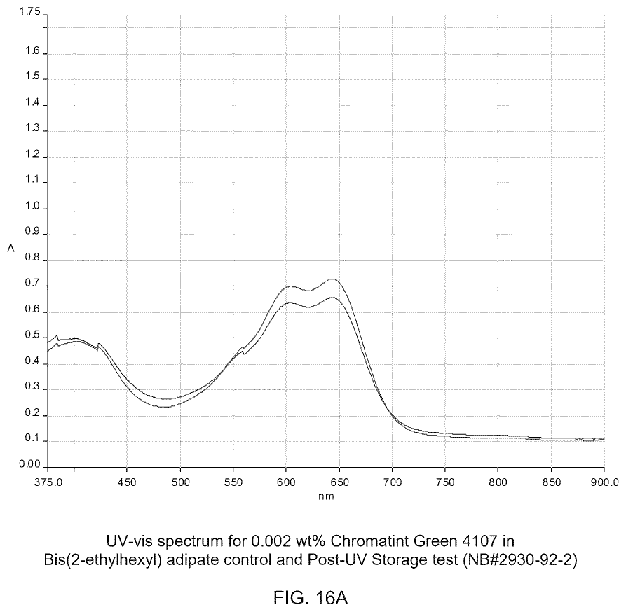

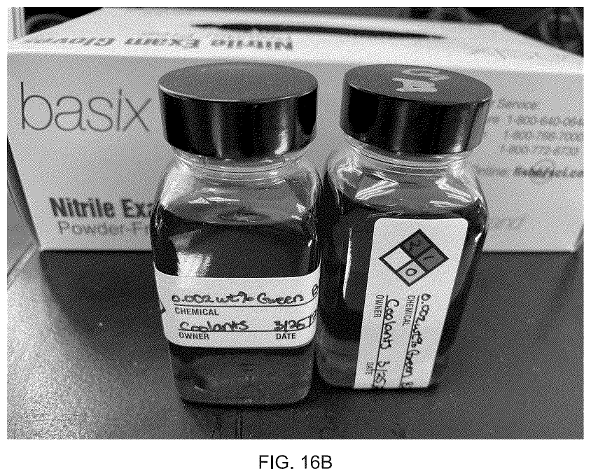

A heat transfer fluid according to described embodiments containing bis(2-ethylhexyl) adipate and 0.002 wt % Chromatint Green X-4107 was subjected to the above-described Accelerated Sunlight Weathering Exposure storage test. The absorption spectrums for the pre-test (or control) and post-test fluid samples are shown in FIG. 16A and it is apparent that the peak in the control sample that is present between about 600-650 nm is also present in the tested sample, which indicates that the dye is stable in the described heat transfer fluid.

FIG. 16B is a photo of the pre-test (sample on the left) and post-test heat transfer fluid (i.e., post Accelerated Sunlight Weathering Exposure Storage test, sample on the right). As shown in the photo of the pre-test (sample on the left, control sample) and the post-test sample (sample on the right), there is little visible change in the color of the post-test sample in comparison with the pre-test sample, indicating that the heat transfer fluid bis(2-ethylhexyl) adipate containing 0.002 wt % Chromatint Green X-4107 is color stable under the Accelerated Sunlight weathering Exposure Storage test conditions used, which is in agreement with the UV-Vis absorption spectrum results shown in FIG. 16A.

### Example 7

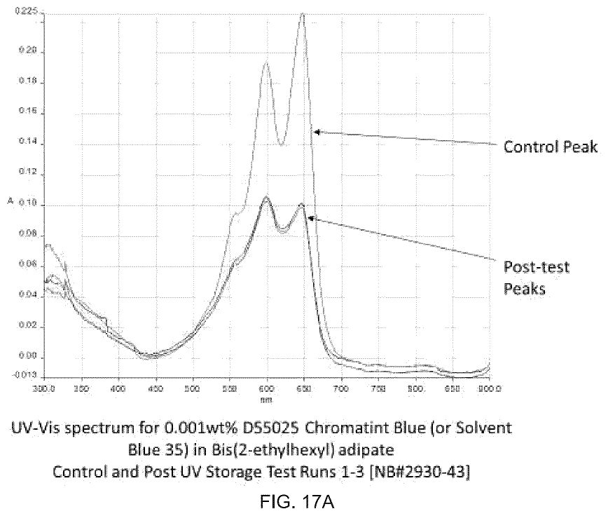

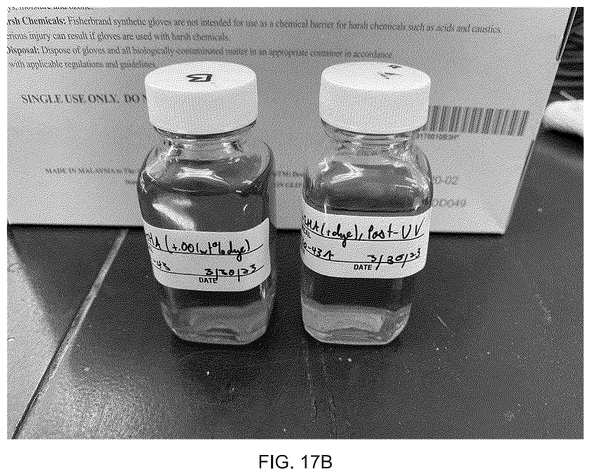

A heat transfer fluid according to described embodiments containing bis(2-ethylhexyl) adipate and 0.002 wt % Chromatint Blue D55025 (1,4-bis(butylamino)anthracene-9,10-dione, C₂₂H₂₆N₂O₂, aka Solvent Blue 35 may be obtained from Chromatech Inc., Canton, MI, USA 48187) was subjected to the above-described Accelerated Sunlight Weathering Exposure storage test. The absorption spectrums are shown in FIG. 17A. It is apparent that the two peaks in the control sample that are present between about 600-650 nm are also present in the tested sample, which indicates that the dye is largely stable in the described heat transfer fluid, although the UV-Vis absorption peaks were reduced by ~50% in the post-test sample as compared to the absorbance peaks in the pre-test sample.

FIG. 17B is a photo of the pre-test (sample on the left) and post-test heat transfer fluid (i.e., post Accelerated Sunlight Weathering Exposure Storage test, sample on the right). Visual inspection of the pre-test and post test samples indicate that blue color remained observable in the post-test sample, which is in agreement with the UV-Vis spectrum results shown in FIG. 17A. In particular, the post-test sample shows a slightly lighter blue color in comparison with the pre-test (or control) sample.

### Corrosion Screening Test Examples

### Modified ASTM D1384 Test

ASTM D1384 is a glassware corrosion test specified for testing of ethylene glycol-water based engine coolant. The test coolant is diluted to 33 vol % with corrosive water. In the following examples, the ASTM D1384 test was modified by testing a neat non-conductive bis(2-ethylhexyl) adipate fluid+colorant fluid without dilution and without adding corrosive salts. Other test conditions were the same as the standard ASTM D1384 test.

### Example 8

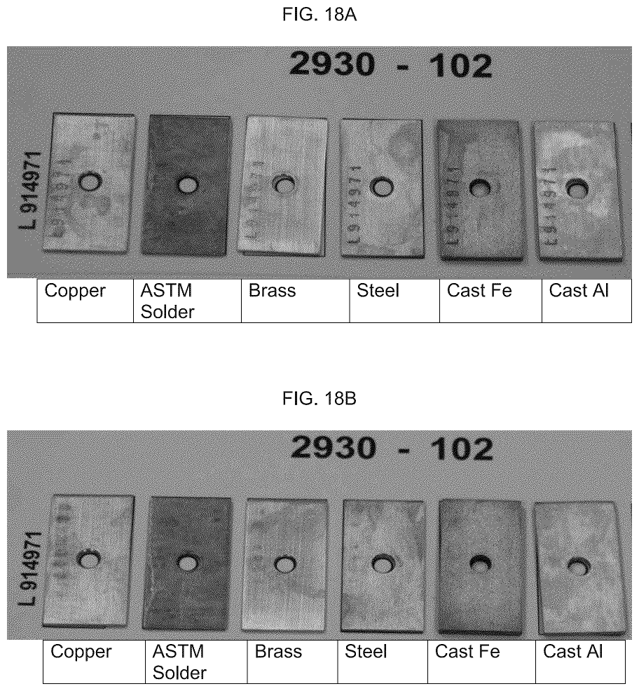

FIG. 18A shows a photo of the front side of six metal specimens: copper, ASTM solder, Brass, Steel, Cast Iron, and Cast Aluminum after being subjected to the Modified ASTM D1384 test and after cleaning per ASTM D1384 specification. Specifically, each of the six specimens were placed into a glass container specified in ASTM D1384 that contained a heat transfer fluid containing 100 wt. % bis(2-ethylhexyl) adipate (99% pure, ThermoFisher Scientific Inc., Waltham, MA 02451). The specimens were allowed to sit at 88° C. for 336 hours per ASTM D1384 specification. No or few visible signs of corrosion were observed on the metal coupons after the test, in agreement with the post-test metal coupon weight loss results shown in Table 3, following.

TABLE 3
Weight Loss Results (mg/specimen)

| Specimen | Copper | ASTM Solder | Brass | Steel | Cast Fe | Cast Al |
|---|---|---|---|---|---|---|
| After test | 1.8 | 0.7 | 0.2 | −1.4 | −1.6 | −4.8 |

FIG. 18B shows a photo of the back side of the same six metal specimens (shown in FIG. 18A) after being tested in the modified ASTM D1384 test and after cleaning per ASTM D1384 specification. As shown in FIGS. 18A and 18B, there is no visible sign of corrosion were observed in the post test metal specimen used in the modified D1384 test, in agreement with the results shown in Table 3.

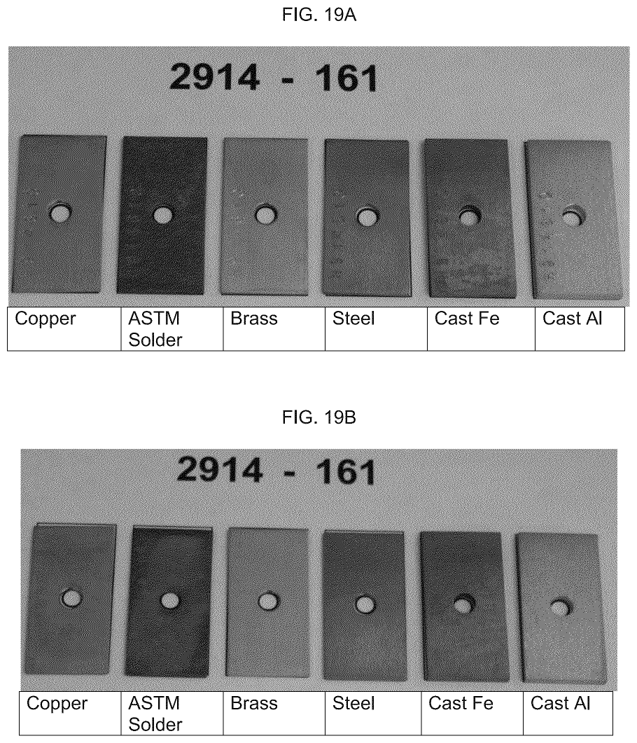

FIG. 19A is a photo of the front side of a blank or control set of metal specimens after cleaning per ASTM D1384 specification.

FIG. 19B is a photo of the back side of the blank or control set of metal specimens shown in FIG. 19A, after cleaning per ASTM D1384 specification.

### Example 9

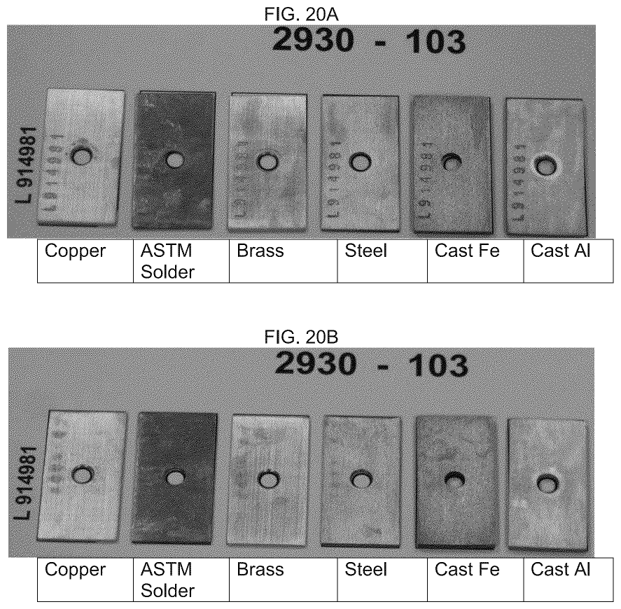

FIG. 20A shows a photo of the front side of six specimens: copper, ASTM solder, Brass, Steel, Cast Iron, and Cast Aluminum after being subjected to the modified ASTM D1384 glassware corrosion screening test and after cleaning per ASTM D1384 specification. Each of the six specimens were placed into a beaker containing a heat transfer fluid containing 99.999 wt % bis(2-ethylhexyl) adipate (99% pure, ThermoFisher Scientific Inc., Waltham, MA 02451) and 0.001 wt % D55025 Blue per ASTM D1384 specification and were tested at 88° C. for 336 hours. The heat transfer fluid was tested without further dilution by water and without adding corrosive salts.

FIG. 20B shows a photo of the back side of six specimens shown in FIG. 15A, after being tested in the modified ASTM D1384 test and after cleaning per ASTM D1384 specification. As shown in FIGS. 20A and 20B, the post-test metal specimens did not exhibit any visible sign of corrosion after the modified ASTM D1384 test, which is in agreement with the weight loss results shown in Table 4.

TABLE 4
Weight Loss Results (mg)

| Metal | | ASTM | | | Cast | Cast |
|---|---|---|---|---|---|---|
| specimen | Copper | Solder | Brass | Steel | Fe | Al |
| After test | 1.0 | −0.3 | 1.0 | 1.3 | −1.9 | −3.2 |

### Example 10

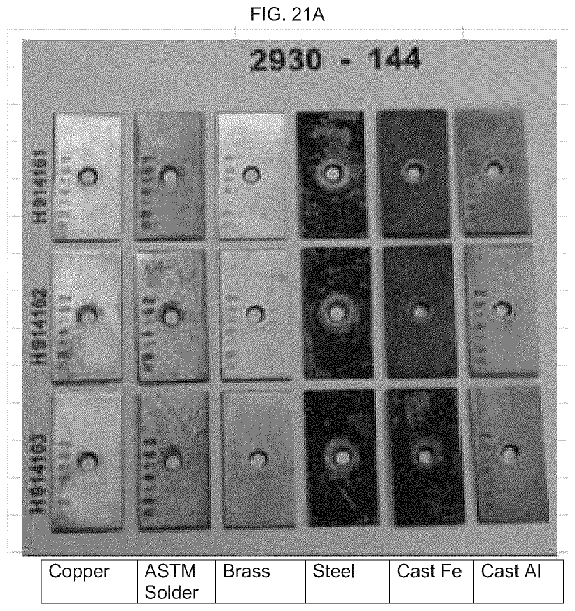

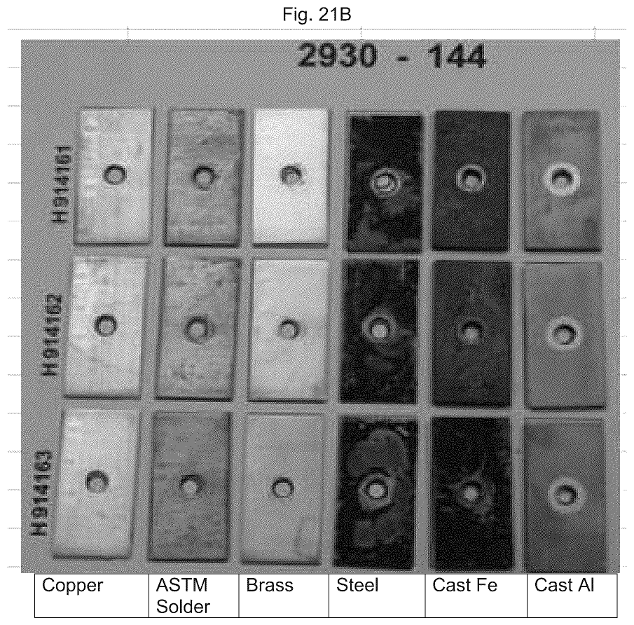

FIG. 21A shows a photo of front side of the three sets of six specimens: copper, ASTM solder, Brass, Steel, Cast Iron, and Cast Aluminum prior to being subjected to the modified ASTM D1384 glassware corrosion screening test and after cleaning per ASTM D1384 specification. Each set of the metal specimens were placed into a beaker (specified in ASTM D1384) containing a prediluted, ready-to-use very low electrical conductivity (nearly electrically non-conductive) coolant identified as OE BEV coolant 1 and were tested in the modified ASTM D1384 test at 88° C. for 336 hours. The prediluted ready-to-use OE BEV coolant 1 was tested without further dilution with water and without the addition of any corrosive salts.

FIG. 21B shows a photo of the back side of the same six metal specimens shown in FIG. 21A. As shown in FIGS. 21A and 21B, visible signs of corrosion were observed in most of metal specimen (e.g., crevice corrosion on copper, brass, and solder, severe general corrosion on carbon steel and cast iron) after the modified ASTM D1384 test in the pre-diluted ready-to-use OE BEV coolant 1, which is consistent with the loss results of the modified ASTM D1384 test shown in Table 5. It is evident from Table 5 that the corrosion weight loss results obtained on the carbon steel and cast iron specimens exceed the limits specified in ASTM D3306 for engine coolant for use in vehicle cooling systems.

TABLE 5
Weight Loss Results (mg/specimen)

| | | ASTM | | | Cast | Cast |
|---|---|---|---|---|---|---|
| Bundle ID | Copper | Solder | Brass | Steel | Fe | Al |
| H914161 | 1.4 | 5.0 | 1.2 | 65.4 | 197.9 | 2.0 |
| H914162 | 0.8 | 4.1 | 0.9 | 64.0 | 154.0 | 0.5 |
| H914163 | 0.8 | 5.1 | 0.6 | 50.6 | 48.5 | 0.9 |
| Avg Result mg | 1.0 | 4.7 | 0.9 | 60.0 | 133.5 | 1.1 |

### Example 11

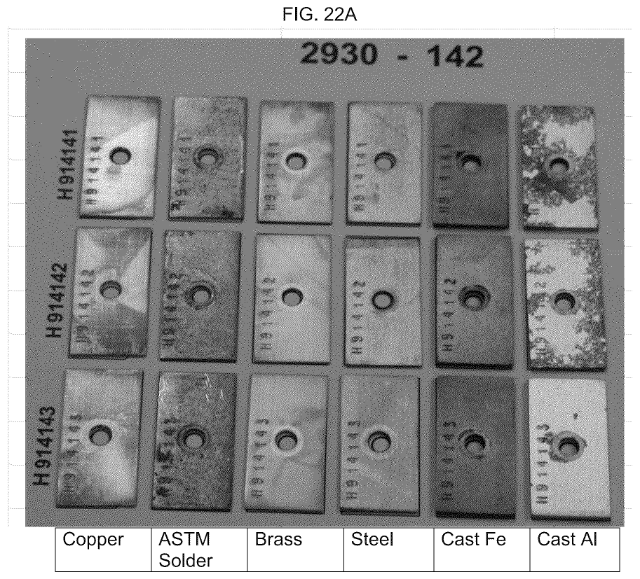

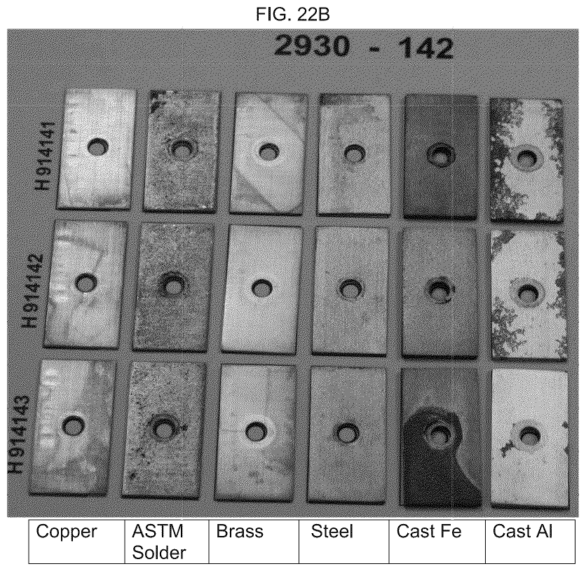

FIG. 22A shows a photo of the front side of the three sets of six specimens: copper, ASTM solder, Brass, Steel, Cast Iron, and Cast Aluminum after being subjected to the modified ASTM D1384 glassware corrosion screening test and after cleaning per ASTM D1384 specification. Each set of the metal specimens were placed into a beaker (specified in ASTM D1384) containing a pre-diluted ready-to-use low electrical conductivity coolant identified as OE BEV coolant 2 and were tested in the modified ASTM D1384 test at 88° C. for 336 hours. The pre-diluted ready-to-use OE BEV coolant 2 was tested without further dilution with water and without the addition of corrosive salts.

FIG. 22B shows a photo of the back side of the same three-sets of six metal specimens shown in FIG. 22A. As shown in FIGS. 22A and 22B, signs of localized corrosion (e.g., crevice corrosion and some pitting corrosion, e.g., on cast aluminum and ASTM solder specimens) were observed on most of the metal specimens used in the modified ASTM D1384 test in the pre-diluted ready-to-use OE BEV coolant 2. It is evident from Table 6 that the corrosion weight loss results obtained on the ASTM solder specimens were higher than the corrosion weight loss limit specified by ASTM D3306 for engine coolants for use in vehicle cooling systems.

TABLE 6
Weight Loss Results (mg)

| | | ASTM | | | Cast | Cast |
|---|---|---|---|---|---|---|
| Bundle ID | Copper | Solder | Brass | Steel | Fe | Al |
| H914141 | 3.4 | 17.4 | 7.8 | 0.0 | −1.6 | 20.7 |
| H914142 | 2.7 | 12.3 | 4.7 | 0.5 | −1.0 | 12.1 |
| H914143 | 3.4 | 15.4 | 7.7 | −0.9 | 51.4 | −0.3 |
| Avg Result mg | 3.2 | 15.0 | 6.7 | −0.1 | 16.3 | 10.8 |

### Radiator Cube Stagnation Test Examples

Radiator cube stagnation tests were conducted according to a test method described in Yang, B., Woyciesjes, P., and Gershun, A., “Comparison of Extended Life Coolant Corrosion Protection Performance”, SAE Technical Paper 2017-01-0627, doi:10.4271/2017-01-0627 and US2019/0225855A1. Briefly, sample Ford Fusion automotive radiator cubes were placed in a 250 ml polypropylene bottle containing 238 ml test heat transfer fluid solution and then placed into test ovens controlled at 100° C., 140° F., and 100° F., respectively for two weeks (or 14 days). After two weeks, the test coolant (or heat transfer fluid) solution was sampled and submitted for analysis. The radiator cubes used in the tests were cut from a Ford Fusion radiator into ~1 inch×1 inch×⅝ inch cubes. 6 radiator cubes weighing 18.7 g±0.3 g were in a test.

After the fourteen days, representative radiator cube samples are removed, visually inspected and photographed, and the heat transfer fluid, in which the radiator cube was placed, was subjected to Inductively Coupled Plasma Spectroscopy to detect the presence of and to measure corrosion and/or corrosion by-product elements (i.e., aluminum ion, and other metal ions analyzed) that have been leached from the radiator cubes.

In addition, the post radiator cube stagnation test heat transfer fluids were visually inspected and photographed before being subjected to exposure to the selected temperatures and after being subjected to exposure to the selected temperatures to determine change to the dye color.

### Example 12

Radiator Cube Stagnation tests according to the above-described method were conducted in a heat transfer fluid containing bis(2-ethylhexyl) adipate and 0.002 wt % quinolone yellow (or solvent yellow 33, C₁₈H₁₁NO₂, 2-quinolin-2-ylindene-1,3-dione, CAS no. 8003-22-3) at 100° C., 140° F., and 100° F., respectively. After the two weeks (14 days) exposure, the heat transfer fluid in each test temperature condition was analyzed by ICP (Inductively Coupled Plasma) Spectroscopy and no corrosion product cations (i.e., aluminum ion, and other metal ions analyzed) were detected.

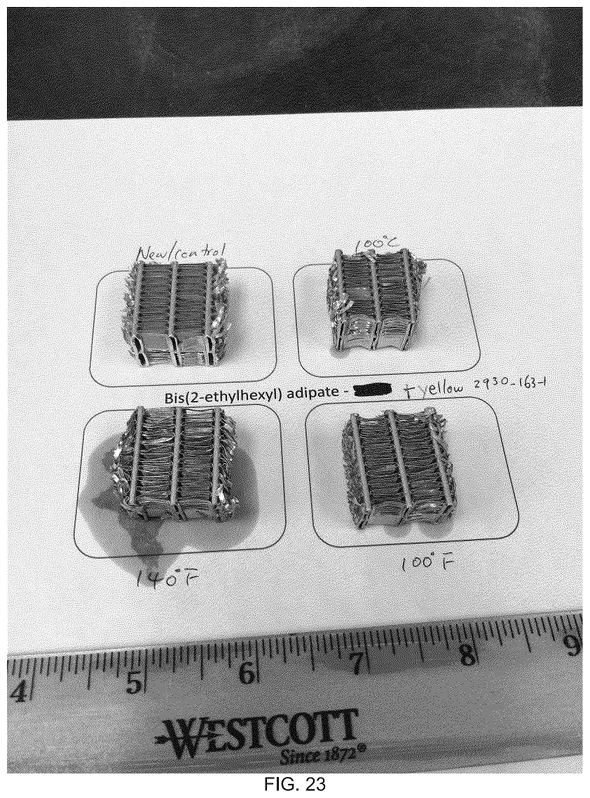

FIG. 23 shows a photograph of the representative radiator cubes after the radiator cube stagnation testing at 100° C., 140° F., and 100° F., respectively, and a control (un-tested) radiator cube. It can be seen that there was no change in the appearance of the post-test radiator cube samples as compared to the control (un-tested) radiator cube sample. It can also be seen that the tested radiator cube samples remained shiny. In addition, the color of the tested heat transfer fluid was visually inspected and it was determined that the color essentially the same as the untested sample. This indicates that the tested dye is compatible with the CAB aluminum heat exchanger surfaces having potassium fluoroaluminate flux residues under the test conditions used. The post-test heat transfer fluid (i.e., 99.998 wt % bis(2-ethylhexyl) adipate with 0.002 wt % quinolone yellow) was free of precipitate and did not exhibit any visible color change after the test. The results obtained in the radiator cube stagnation test indicate that the tested heat transfer fluid containing bis(2-ethylhexyl) adipate and 0.002 wt % quinolone yellow dye is compatible with CAB aluminum heat exchanger surfaces with potassium fluoroaluminate flux residues under the test conditions used.

### Example 13

Radiator Cube Stagnation tests according to the above-described method were conducted in a heat transfer fluid containing bis(2-ethylhexyl) adipate and 0.002 wt % solvent green 3 (1,4-bis(p-tolylamino)anthracene-9,10-dione, CAS no. 128-00-3, C₂₈H₂₂N₂O₂, or Quinizarin Green SS) at 100° C., 140° F., and 100° F., respectively. After the two weeks (14 days) exposure, the heat transfer fluid in each test temperature condition was analyzed by ICP (Inductively Coupled Plasma) Spectroscopy and no corrosion product cations (i.e., aluminum ion, and other metal ions analyzed) were detected.

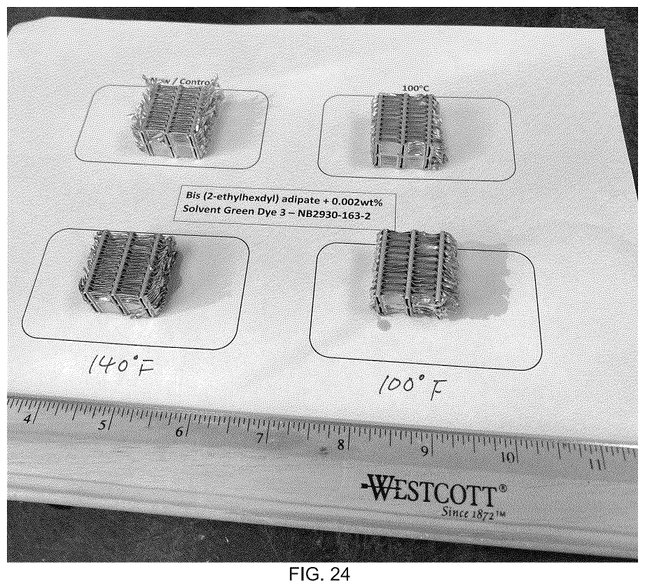

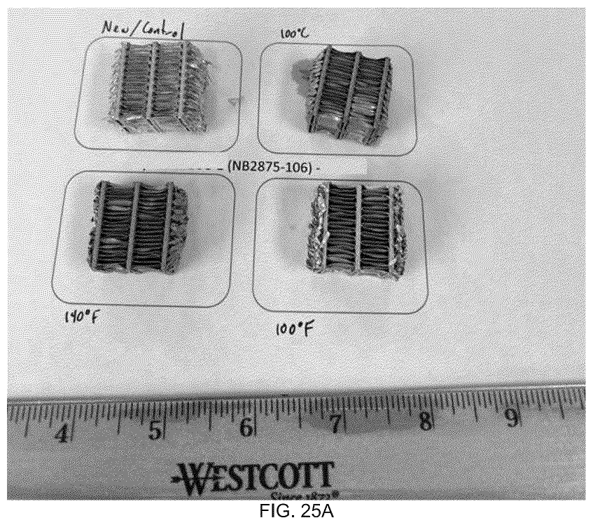

FIG. 24 shows a photograph of the representative radiator cubes after the radiator cube stagnation testing at 100° C., 140° F., and 100° F., respectively, and a control (un-tested) radiator cube. It can be seen that there was no change in the appearance of the post-test radiator cube samples as compared to the control (un-tested) radiator cube sample. It can also be seen that the tested radiator cube samples remained shiny. In addition, the color of the tested heat transfer fluid was visually inspected and it was determined that the color essentially the same as the untested sample. This indicates that the tested dye is compatible with the CAB aluminum heat exchanger surfaces having potassium fluoroaluminate flux residues under the test conditions used. The post-test heat transfer fluid (i.e., 99.998 wt % bis(2-ethylhexyl) adipate with 0.002 wt % solvent green 3 dye) was free of precipitate and did not exhibit any visible color change after the test.

### Example 14

Comparative Radiator Cube Stagnation tests according to the above-described method were conducted in a commercial heat transfer fluid, pre-diluted ready-to-use coolant identified as OE BEV coolant 2 at 100° C., 140° F., and 100° F., respectively. After the two weeks exposure, the heat transfer fluid in each test bottle was analyzed by ICP (Inductively Coupled Plasma) Spectroscopy and it was found that there was a substantial depletion of corrosion inhibitors, i.e., silicate or Si based inhibitors, present in the heat transfer fluid. In addition, a visual inspection of the OE BEV coolant 2 tested at 100° C. revealed floating deposits and precipitates.

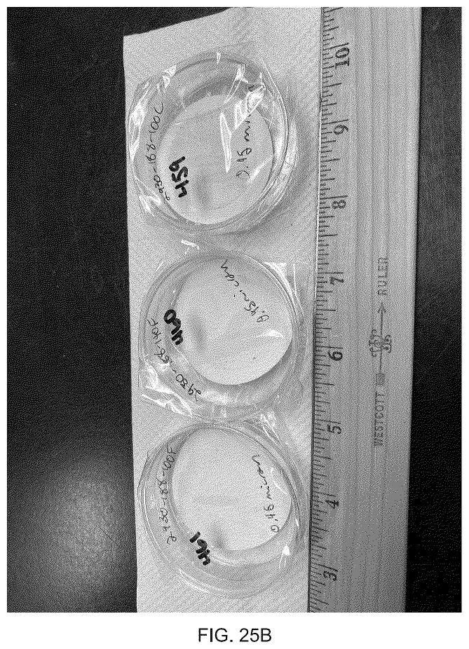

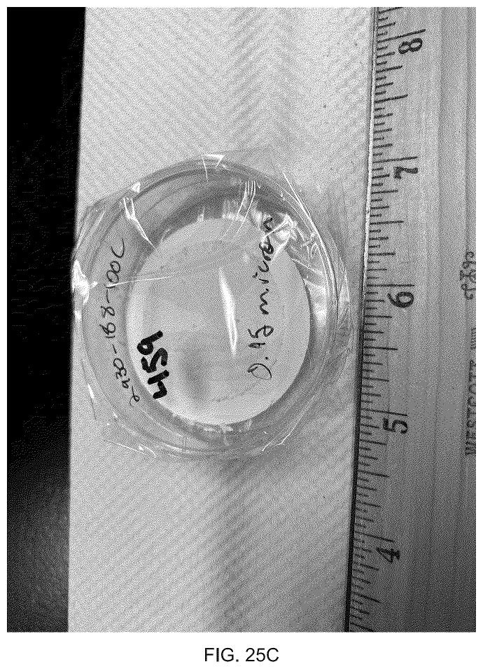

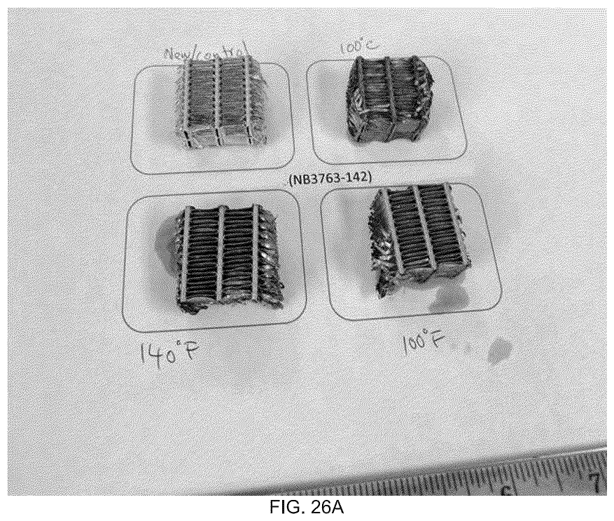

Signs of corrosion (e.g., darkening of aluminum alloy surfaces of the radiator cubes) were observed in the post-test radiator cubes under all three test temperature conditions. Corrosion attack on the post-test radiator cubes appears to be more severe at the higher-test temperatures of 100° C. and 140° F. than at 100° F., as shown in FIG. 25A for the representative radiator cubes after the radiator cube stagnation testing at 100° C., 140° F., and 100° F., respectively, and a control (un-tested) radiator cube.

Moderate amounts (a few mm³ in volume for the test at 100° C.) of corrosion products in the form of gels (upon drying, it became white crystalline material) were observed and collected by filtering the post-test prediluted ready-to-use OE BEV coolant 2 solutions. The amount of corrosion product deposits collected were found to be increasing with increasing test temperature, i.e., significantly more corrosion product deposits were collected from the post 100° C. radiator cube stagnation test solution than the ones collected from the post 140° F. test and the post 100° F. test solutions

FIG. 25B is a photo of the air-dried deposits collected from filtering the post-test solutions of the radiator cube stagnation tests described with respect to FIG. 25A after conducting the tests for 2 weeks at 100° C., 140° F., and 100° F., respectively in a prediluted ready-to-use low electrical conductivity OE BEV coolant 2, where the filtering was conducted using a 0.45 μm filter paper for a post-test solution collected under each test temperature condition.

FIG. 25C is a photo of the air-dry deposits collected from filtering the post-test solution of the radiator cube stagnation test described with respect to FIG. 25A after conducting the test for 2 weeks at 100° C. in the prediluted ready-to-use low electrical conductivity OE BEV coolant 2.

### Example 15

Comparative Radiator Cube Stagnation tests according to the above-described method were conducted in a 50 v % commercial heat transfer fluid, identified as OE BEV Coolant 3 at 100° C., 140° F., and 100° F., respectively. After the two weeks exposure, the heat transfer fluid in each test bottle was analyzed by ICP (Inductively Coupled Plasma) Spectroscopy and it was found that there was a substantial depletion of corrosion inhibitors, i.e., silicate or Si based inhibitors, as well as the presence of cation corrosion product in the heat transfer fluid.

It was found that the aluminum ion content in the post test coolant samples at three test temperatures was below the detection limit (i.e., 2 mg/L) due to formation of corrosion products and due to dropping out from the coolant solutions. In addition, gel like deposits were observed in the post-test solution of the 50 v % OE BEV Coolant 3 that was tested at 100° C.

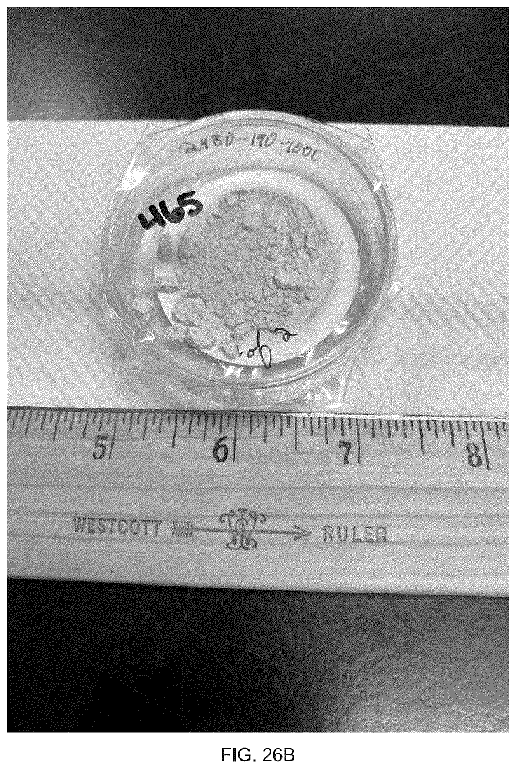

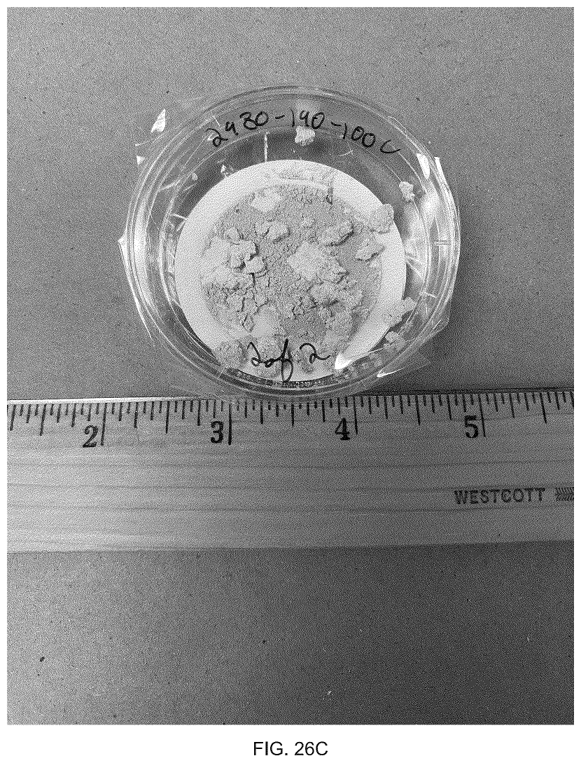

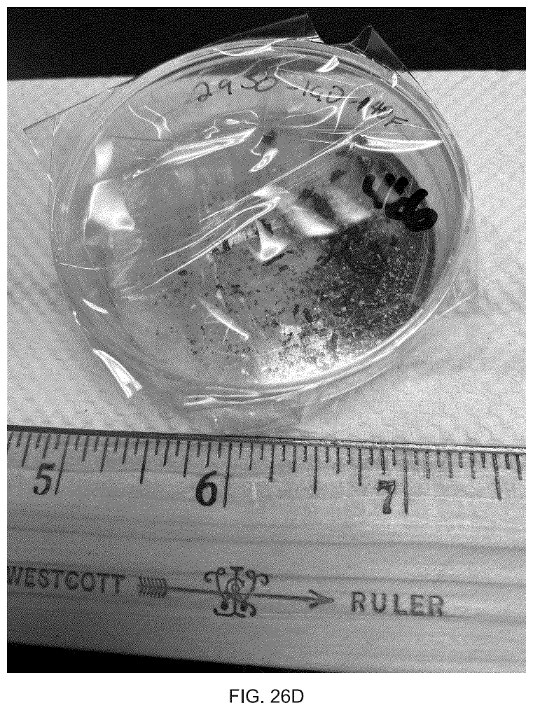

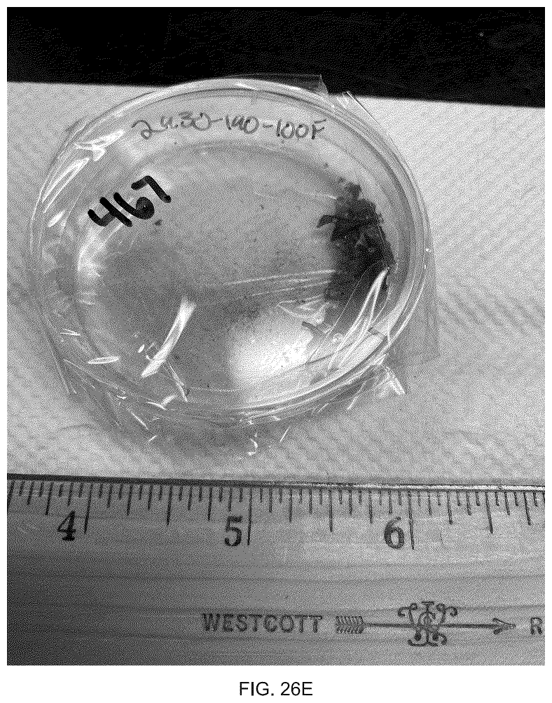

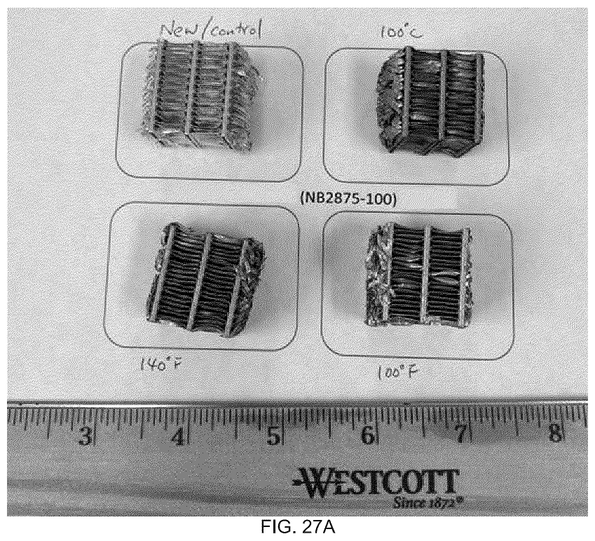

FIG. 26A shows a photograph of the representative radiator cubes after the radiator cube stagnation testing at 100° C., 140° F., and 100° F., respectively, and a control (un-tested) radiator cube. It can be seen that corrosion is evident along with discoloration or blackening of the aluminum surfaces and gelling or deposit formation (and plugging of the radiator tubes).

Signs of significant corrosion attack (e.g., blackening of the aluminum alloy surfaces of the radiator cubes, localized corrosion, gel or corrosion product deposits on parts of the radiator tube interior surfaces) on post-test radiator cubes were observed under all three test temperature conditions. Corrosion attack on the post-test radiator cubes appears to be more severe with increasing test temperature. Substantial amounts (e.g., more than 1 cm³ in volume for the test at 100° C.) of corrosion products and deposits (in the form of a gel under the 140° F. and 100° F. test conditions) were observed and collected by filtering the post-test 50 v % Aftermarket EV coolant (or OE BEV coolant 3) solutions. The amount of the filter collected deposits and/or corrosion products were found to increase with increasing test temperature as shown in FIGS. 26B, 26C, 26D and 26E.

FIG. 26B is a photo of the air-dried deposits collected from using the first piece of filter paper (two pieces of 0.45 μm filter paper were used to filter the post-test solution for this test condition) to filter about half of the post-test solution of the radiator cube stagnation after conducting the test for 2 weeks at 100° C. in 50 vol % of the aftermarket high electrical conductivity EV coolant (i.e., 50 vol % OE BEV coolant 3).

FIG. 26C is a photo of the air-dried dry deposits collected from using the second piece of filter paper to filter the remainder of the post-test solution of the radiator cube stagnation after conducting the test for 2 weeks at 100° C. in 50 v % aftermarket high electrical conductivity EV coolant (i.e., 50 vol % OE BEV coolant 3).

FIG. 26D is a photo of the air-dried deposits collected from filtering the post-test solution of the radiator cube stagnation test after conducting the test for 2 weeks at 140° F. in 50 vol. % aftermarket high electrical conductivity coolant (i.e., 50 vol. % OE BEV coolant 3).

FIG. 26E is a photo of the air-dried deposits collected from filtering the post-test solution of the radiator cube stagnation test after conducting the test for 2 weeks at 100° F. in 50 vol. % aftermarket high electrical conductivity coolant (i.e., 50 vol % OE BEV coolant 3).

### Example 16

Comparative Radiator Cube Stagnation tests according to the above-described method were conducted in a 50 v % commercial heat transfer fluid identified as 50 v % OE BEV Coolant 4 at 100° C., 140° F., and 100° F., respectively. After the two weeks exposure, the heat transfer fluid in each test bottle was analyzed by ICP (Inductively Coupled Plasma) Spectroscopy and it was found that there was a substantial depletion of corrosion inhibitors, i.e., silicate or Si based inhibitors, as well as the presence of cation corrosion product (i.e. aluminum) in the heat transfer fluid.

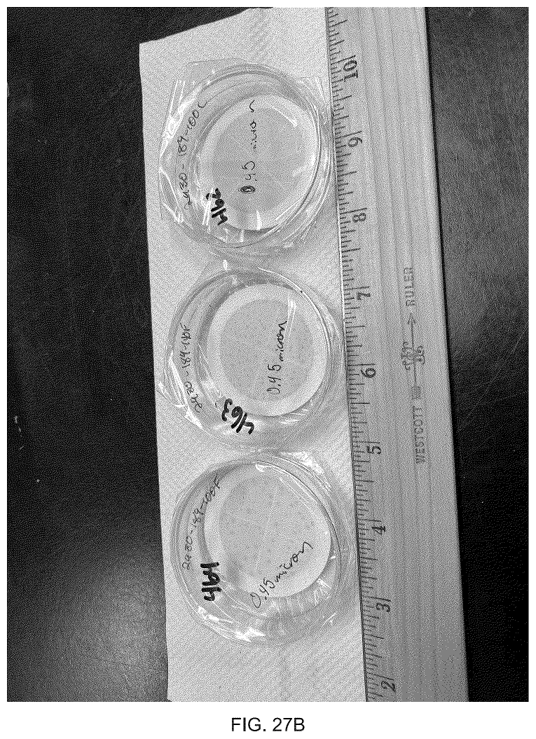

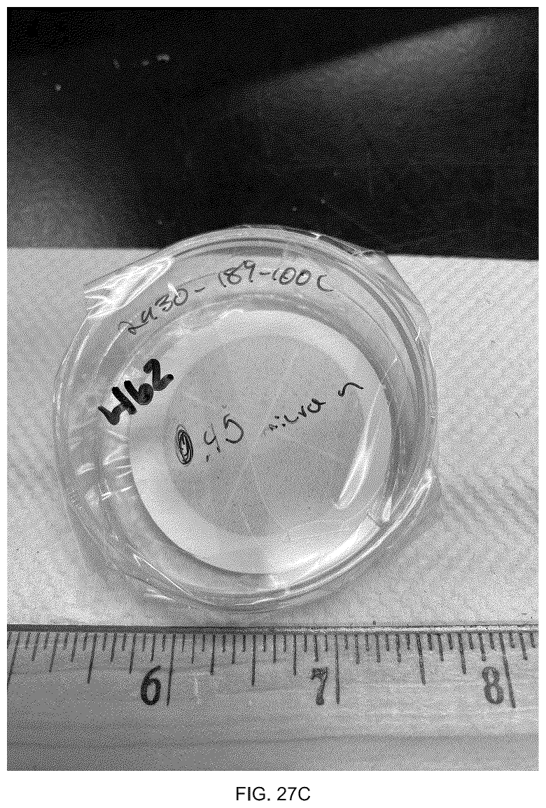

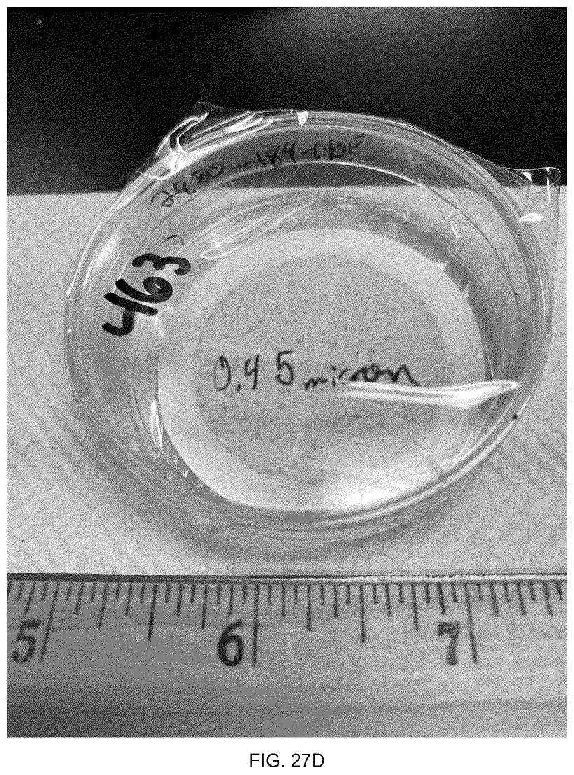

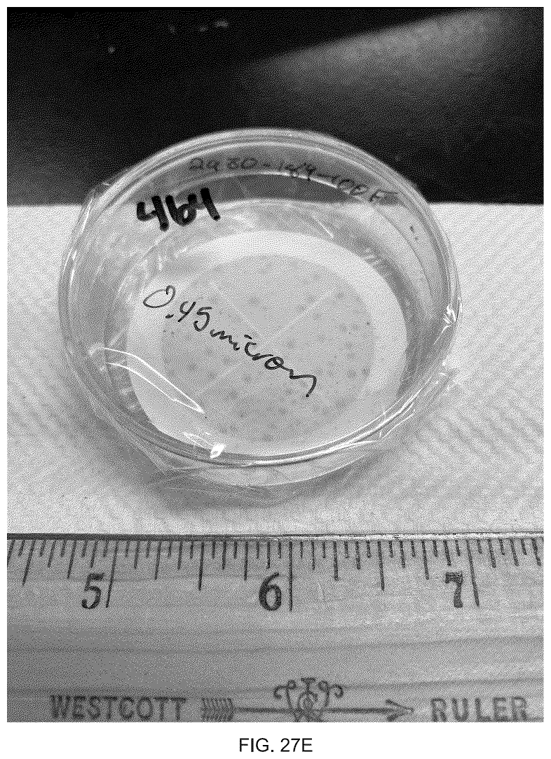

Corrosion attack on the post-test radiator cubes appears to be more severe with increasing test temperature, as shown in FIG. 27A. Moderate amounts (a few mm³ in volume for the test at 100° C.) of corrosion products were observed and collected by filtering the post-test 50 vol. % OE BEV coolant 4 test solutions. The amount of corrosion product deposits collected from filtering the post-test solutions was found to increase with increasing test temperature.

FIG. 27A shows a photograph of the representative radiator cubes after the radiator cube stagnation testing at 100° C., 140° F., and 100° F., respectively, and a control (un-tested) radiator cube. It can be seen that corrosion is evident along with discoloration or blackening of the aluminum surfaces.

FIG. 27B is a photo of the air-dried deposits collected from filtering (using a 0.45 μm filter paper for each test temperature) the post-test solutions of the radiator cube stagnation tests after conducting the tests for 2 weeks at 100° C. in 50 vol % OE BEV coolant 4.

FIG. 27C is a photo of the air-dried dry deposits collected from filtering (using a 0.45 μm filter paper for each test temperature) the post-test solutions of the radiator cube stagnation tests after conducting the tests for 2 weeks at 100° C. in 50 vol % OE BEV coolant 4.

FIG. 27D is a photo of the air-dried dry deposits collected from filtering (using a 0.45 μm filter paper for each test temperature) the post-test solutions of the radiator cube stagnation tests after conducting the tests for 2 weeks at 140° F. in 50 vol % OE BEV coolant 4.

FIG. 27E is a photo of the air-dried deposits collected from filtering (using a 0.45 μm filter paper for each test temperature) the post-test solutions of the radiator cube stagnation tests after conducting the tests for 2 weeks at 100° F. in 50 vol % OE BEV coolant 4.

### Galvanic Corrosion Test Examples

In the following examples, the galvanic corrosion of cast aluminum alloy SAE329 in the presence of DC voltage was tested to evaluate the potential fire risk of EV coolant in case of leakage due to an accident. In each example, a cathode and anode, each formed of cast aluminum alloy SAE329 to provide 6 cm² exposed surface area were placed into the heat transfer fluid to be tested, were separated by 1 cm, and subjected to 5V DC at 21° C.±1° C. for a period of 3600 seconds (one hour). The current density was measured over the entire time period and plotted as shown in FIG. 23.

### Example 17

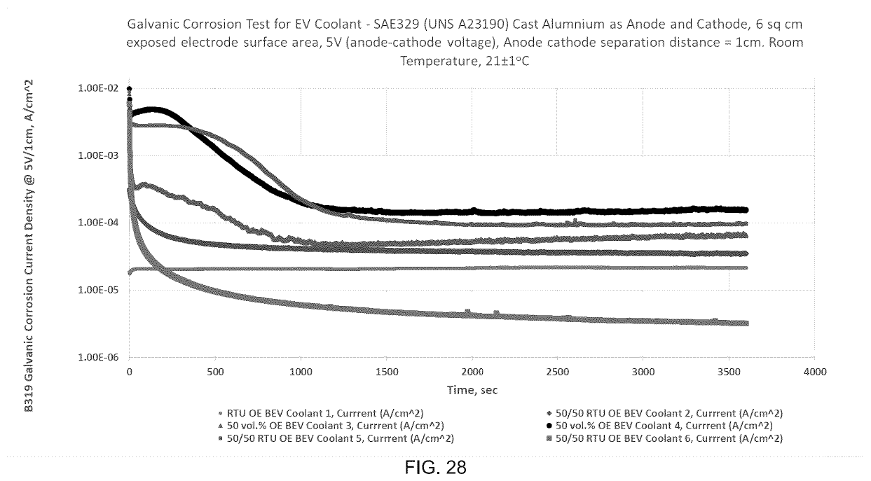

The following heat transfer fluids (having the compositions as noted in Table 7, below) were tested according to the galvanic corrosion test described above:
(a) Prediluted Ready-to-Use OE BEV Coolant 5
(b) 50 v % OE BEV Coolant 3
(c) Prediluted Ready-to-Use, OE BEV Coolant 2
(d) Prediluted Ready-to-Use OE BEV Coolant 1
(e) Prediluted 50/50 Ready-to-Use OE BEV Coolant 6
(f) 50 v % OE BEV Coolant 4
   As noted above, the current density was measured over the entire time period and plotted as shown in FIG. 28 and it is evident that the current density typically significantly decreased over time, except for Prediluted Ready-to-Use OE BEV Coolant 1. Very high steady-state galvanic corrosion current density values were observed in 50 vol. % OE BEV Coolant 4, and Prediluted Ready-to-Use OE BEV Coolant 5. High steady-state galvanic corrosion current density values were observed in 50 vol. % OE BEV Coolant 3 and low electrical conductivity Prediluted Ready-to-Use OE BEV Coolant 2.

TABLE 7
Commercial Aftermarket Engine Coolant and OE BEV Coolants Tested

| | Aftermarket | | | | | | |
|---|---|---|---|---|---|---|---|
| | Long Life | OE BEV | OE BEV | | | | OE BEV |
| | Engine | Coolant 1, | Coolant 2, | OE BEV | OE BEV | OE BEV | Coolant 6, |
| Key Components | Coolant | Prediluted | Prediluted | Coolant 3 | Coolant 4 | Coolant 5 | Prediluted |
| Ethylene Glycol, wt % | >90 | 50-55 | 55-60 | >90 | >90 | 50-55 | 50-55 |
| Tolytriazole, mg/L | 1000-1200 | — | — | — | 900-1200 | 500-700 | 400-600 |
| Benzotriazole, mg/L | — | 2000-2300 | — | 1100-1400 | 900-1200 | 500-700 | — |
| Nitrate, mg/L | — | — | — | 2200-2600 | 3000-4000 | 800-1000 | — |
| Phosphoric acid as P, mg/L | — | — | — | — | — | — | 0.03-0.06 |
| Silicate and Silicone Stabilizer | — | — | — | 250-350 | 150-300 | 100-200 | — |
| as Si, mg/L | | | | | | | |
| Organosilicon compound, such | — | — | 350-600 | — | — | — | — |
| as N,O-bis(trimethylsilyl) | | | | | | | |
| acetamide or N-trimethylsilyl | | | | | | | |
| acetamide) disclosed in | | | | | | | |
| U.S. Pat. No. 869,111,0B2, as Si, mg/L | | | | | | | |
| Sebacic acid, wt % | 0.4-0.5 | — | — | 0.9-1.3 | 3.0-4.0 | 1.8-2.2 | — |
| 2-Ethyl hexanoic acid, wt % | 2.7-2.8 | — | — | 1.7-2.0 | — | — | 1.2-1.5 |
| Neodecanic acid, wt % | — | — | — | — | — | — | 0.4-0.5 |
| NaOH or KOH, wt % | 0.15-0.2 | Trace | Trace | 0.15-0.25 | 0.15-0.3 | 0.15-0.3 | 0.1-0.2 |
| Water, Antifoam and Dyes, | Balance | Balance | Balance | Balance | Balance | Balance | Balance |
| wt % | | | | | | | |
| Electrical Conductivity, | 2500-3000 | <5 | <150 | 3900-4300 | 4700-5000 | 4800-5100 | 2300-2600 |
| Prediluted or 50 v % | | | | | | | |
| Concentrate, μS/cm @ 20 to | | | | | | | |
| 25° C. | | | | | | | |

Note:
BEV = Battery Powered Electric Vehicle. OE = Original Equipment or Factory Fill Coolant

### Example 18

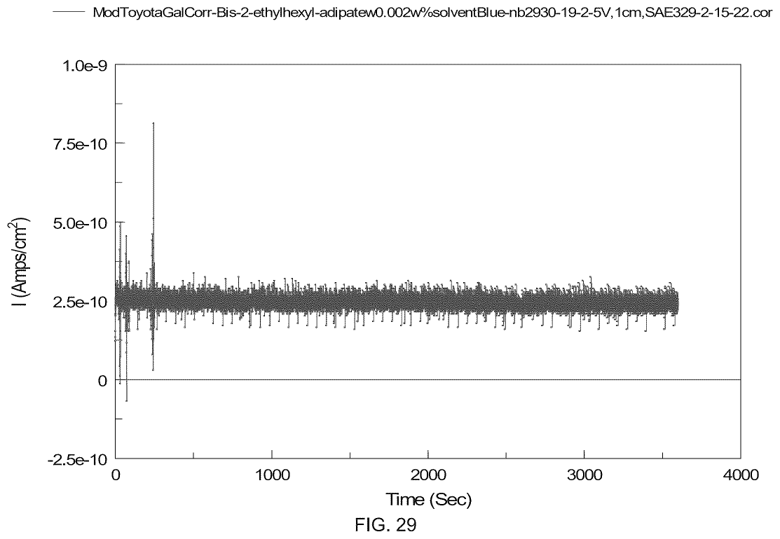

An electrically non-conductive non-aqueous coolant heat transfer fluid containing bis(2-ethylhexyl) adipate and 0.002 wt % Solvent blue 35 dye was tested according to the galvanic corrosion test procedure described above. The results are shown in FIG. 29. It was observed that a much lower galvanic corrosion current density was detected as compared to the comparative heat transfer fluids of Example 17.

### Example 19

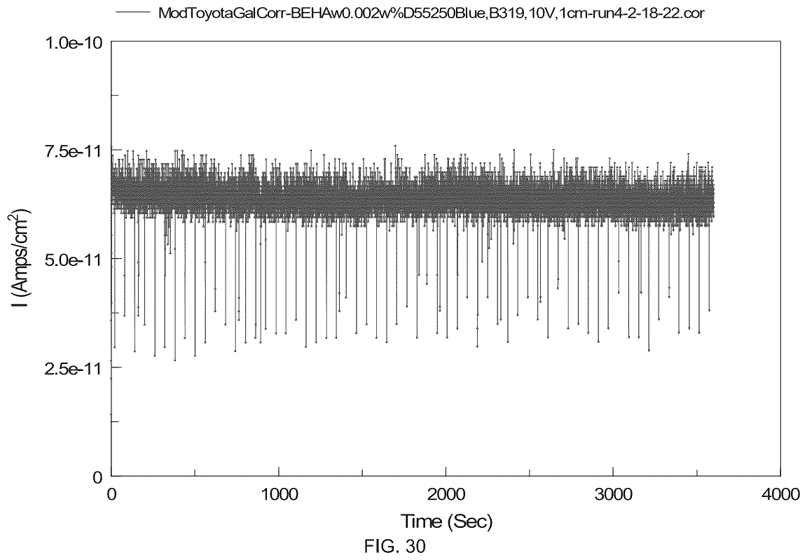

An electrically non-conductive non-aqueous coolant heat transfer fluid containing bis(2-ethylhexyl) adipate and 0.002 wt % Solvent blue 35 dye was tested according to the galvanic corrosion test procedure described above except that the voltage was 10 VDC/cm. The results are shown in FIG. 30. It was observed that a much lower galvanic corrosion current density was detected as compared to the comparative heat transfer fluids of Example 17.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While the above-described compositions may include one more of the above-enumerated ingredients, it is contemplated that the compositions may exclude the presence of any of the above-enumerated ingredients.

While the concepts of the present disclosure are susceptible to various modifications and alternative forms, specific exemplary embodiments of the disclosure have been shown by way of example in the drawings. It should be understood, however, that there is no intent to limit the concepts of the present disclosure to the particular disclosed forms; the intention is to cover all modifications, equivalents, and alternatives falling within the spirit and scope of the invention as defined by the claims.

1. A heat transfer fluid comprising bis(2-ethylhexyl) adipate.

2. The heat transfer fluid of claim 1 wherein the heat transfer fluid comprises at least 90 wt % of bis(2-ethylhexyl) adipate.

3. The heat transfer fluid of claim 1 wherein the heat transfer fluid comprises at least 99 wt % of bis(2-ethylhexyl) adipate.

4. The heat transfer fluid of claim 1 further comprising one or more ultraviolet and sunlight stable, electrically non-conductive solvent colorant or one or more water insoluble colorants.

5. The heat transfer fluid of claim 4 wherein the colorant includes a chromophore selected from anthraquinone, triphenylmethane, diphenylmethane, triarylmethane, diarylmethane, azo containing compounds, disazo (or bishydrazone) containing compounds, trisazo containing compounds, diazo containing compounds, xanthene, acridine, indene, thiazole, two or more conjugated aromatic groups, two or more conjugated heterocyclic groups (e.g., stilbene, and/or pyrazoline, and/or coumarine type radicals or combinations thereof), three or more conjugated carbon-carbon double bonds (e.g., carotene), and combinations thereof.

6. The heat transfer fluid of claim 5 wherein the chromophore is selected from triphenylmethane, diphenylmethane, triarylmethane, diarylmethane, an azo containing radical, and combinations thereof.

7. The heat transfer fluid of claim 4, wherein the colorant contains an aliphatic group, an aromatic group, or a combination of an aliphatic and aromatic group.

8. The heat transfer fluid of claim 4 further comprising one or more mono- or di-esters.

9. The heat transfer fluid of claim 4 wherein the one or more mono- or di-esters are selected from isopropyl oleate, iso-butyl oleate, 2-ethyl hexyl laurate, 2-ethyl hexyl oleate, di(2-ethylhexyl) azelate, di(2-ethylhexyl) sebacate, neopentyl glycol di-heptanoate, neopentyl glycol di-nonanoate, neopentyl glycol di-octanoate, neopentyl glycol di-decanoate, neopentyl glycol 2-ethyl hexanoate, propylene glycol dihexanoate, propylene glycol diheptanoate, propylene glycol dicaprylate, propylene glycol dicaprylate/dicaprate, propylene glycol dinonanoate, propylene glycol diethylhexanoate, propylyene glycol diisononanoate, propylene glycol dicaprate, propylene glycol diperlargonate, propylene glycol laurate, butylene glycol diheptanoate, butylene glycol dicaprylate, butylene glycol dicaprylate/dicaprate, butylene glycol dihexanoate, butylene glycol dinonanoate, butylene glycol diethylhexanoate, butylene glycol diisononanoate, and isopropyl C₁₀ to C₂₄ aliphatic carboxylate, methyl octanoate, methyl nonanoate, methyl decanoate, methyl laurate, methyl oleate, methyl-C₇ to C₂₄ aliphatic carboxylate, iso-butyl C₁₀ to C₂₄ aliphatic carboxylate, 2-ethyl hexyl C₁₀ to C₂₄ aliphatic carboxylate, di-(C₃ to C₂₄ branched or straight chain aliphatic carboxylate) adipate, and combinations thereof.

10. The heat transfer fluid of claim 1 further comprising one or more optional components selected from antifoams, antioxidants, corrosion inhibitors, anti-wear agents, acid control additives, viscosity improving agents, azole compounds, and other additives.
